(19) United States
(12) Patent Application Publication
(10) Pub. No.: US 2012/0326509 A1
(43) Pub. Date: Dec. 27, 2012

(54) DUTY CYCLE CONTROLLER

(76) Inventor: William MCSHEFFREY, Morrisburg (CA)

(21) Appl. No.: 13/597,826

(22) Filed: Aug. 29, 2012

Related U.S. Application Data
(63) Continuation-in-part of application No. PCT/CA2011/000213, filed on Mar. 1, 2011.
(60) Provisional application No. 61/529,327, filed on Aug. 31, 2011.

(51) Int. Cl. H02J 3/00

(52) U.S. Cl. 307/39; 307/126

(57) ABSTRACT

There is provided systems, methods and devices configured to supply the load requirements of any resistive, inductive, or combination device while restricting electrical energy that does not contribute to the load requirement, wherein the load requirement is defined as the amount of electrical energy required for the device to substantially achieve its objective. As found in most such loads, segments of the AC or DC signal are redundant or are not useful to a load in achieving any of its objectives. Predetermined objectives may include maintaining the production of light, motor power, or other load outputs at the same level as non-restricted loads, reduction or production of electromagnetic interference, harmonics, or other types of interference, heat production or reduction, regulation of any other wanted or unwanted output of such loads, or a combination thereof.

The present application claims the benefit of U.S. provisional application No. 61/529,327, filed Aug. 31, 2011, and is a continuation-in-part of PCT application No. PCT/CA2011/000213, filed Mar. 1, 2011, which claims the benefit of U.S. provisional application No. 61/309,196, filed Mar. 1, 2010, all of which are herein incorporated by reference.

### FIELD OF THE TECHNOLOGY

The present subject matter relates to systems, methods and devices for increasing the efficiency of the desired output of resistive, inductive, or combination loads. The subject matter of the instant disclosure is directed to systems, methods and devices that restrict electrical energy that is substantially redundant or non-useful in achieving a particular objective. It can be used in conjunction with alternating current (“AC”) or direct current (“DC”), or a combination thereof, for consumed or generated electrical power for commercial, non-commercial and industrial purposes, including, without limitation, from hydro (water), wind, solar, burning of fossil fuels, nuclear, and other sources of electricity. It can apply to single-, double- or multi-phases. Disclosed herein are systems, methods and devices configured to supply electrical energy to the load of any resistive, inductive, or combination device while restricting non-contributing electrical energy, or a portion thereof, wherein the non-contributing electrical energy is defined as the electrical energy that does not contribute to substantially achieving an objective of the resistive, inductive, or combination device.

### BACKGROUND

Load affects the performance of circuits that output AC voltages or currents, such as sensors, voltage sources, and amplifiers. Household power outlets are a typical voltage source, typically outputting 120V AC, with household appliances being plugged into the outlet making up the load. When such appliances are switched on, the load impedance presented by the appliance to the voltage source may be dramatically reduced, causing the output voltage to drop.

In North America, the typical 120 AC source consists of a three wire system: a green wire designated as the system ground, having no voltage present if connected properly; a white wire, also at zero or a very low voltage potential, which is designated as the return (in some aspects, sometimes referred to as the “low” or neutral wire); and the black wire (in some aspects, sometimes referred to as the “hot” or “high” wire). Measurements made between the return and ground wire in normal operation indicates no voltage potential.

In a simple AC circuit consisting of the source and a linear load, both the current and voltage are in phase. As found in most resistive, inductive or combination loads, segments of each AC cycle are redundant or not used efficiently. As a result, the power factor is reduced. A typical example can be found in the use of 95% of compact fluorescent light bulbs (in some aspects, sometimes referred to as “CFL” bulbs) that generally have a relatively low power factor.

Fluorescent light bulbs are associated with health, environmental and high cost issues, which are not observed to the same degree in incandescent light bulbs. Incandescent light bulbs, however, will not light until the voltage reaches a particular level, during which time, the light bulb is drawing current which is substantially only capable of creating heat, rather than light.

In U.S. Pat. No. 7,233,112, issued to Burke et al. (hereinafter “Burke”), there is disclosed a means for switching off electrical transmission during portions of a sinusoidal transmission at the front and back of each sine wave to reduce the transmission of electrical energy to a light.

U.S. Pat. No. 5,455,491, issued to Hajagos et al. (hereinafter “Hajagos”), is directed to maintaining the so called “unity power factor” of a load at optimal level. In an electric power system, a load with a low power factor draws more current than a load with a high power factor for the same amount of useful power transferred. The higher currents increase the energy lost in the distribution system, and require larger wires and other equipment. Because of the costs of larger equipment and wasted energy, electrical utilities will usually charge a higher cost to industrial or commercial customers where there is a low power factor. Hajagos is related to switching current flow through a load in order to adjust that load's unity power factor to thereby save energy.

U.S. Pat. No. 6,057,674, issued to Bangerter (hereinafter “Bangerter”), discloses transmission of electrical energy from a power source that is diverted when portions of each sine wave in the sinusoidal electrical signal reach certain pre-determined levels and diverted to capacitors, which are configured to provide the energy in an alternative manner. The diversion of electrical energy to the capacitors are configured to divert energy that, if switched off to prevent unwanted voltage spikes, would cause high levels of unwanted harmonics, electromagnetic interference or other interference.

All of the above references are incorporated herein by reference.

The examples and objectives described above are included solely to advance the understanding of the subject matter described herein and are not intended in any way to limit the subject matter to aspects that are in accordance with the examples or improvements described above.

### SUMMARY

The present subject matter is directed to systems, methods and devices for increasing the efficiency of achieving desired outputs in electrical loads.

In one aspect, the subject matter disclosed herein is directed to systems, methods and devices configured to supply an amount of electrical energy required for a resistive, inductive, or combination load device to substantially achieve its predetermined objective and to restrict electrical energy, or a portion thereof, which does not substantially contribute to the load achieving the predetermined objective.

A further aspect of the subject matter disclosed herein provides for a device for reducing the consumption of electrical energy of resistive, inductive or combination loads comprising: a duty cycle controller having a first zero switch and a second zero switch connected to a reference controller and a drop out switch, the reference controller continuously connected to a line voltage, wherein the duty cycle controller is configured to switch off the current to the load when the reference controller determines that the line voltage is within a first predetermined threshold range and switch on current to the load with the reference controller determines that the line voltage is within a second predetermined threshold range, the first predetermined threshold range associated with electrical energy that is not useful for the load to achieve a predetermined objective and the second predetermined threshold range associated with electrical energy that is useful for the load to achieve the predetermined objective.

A further aspect of the subject matter disclosed herein provides for a method for reducing the consumption of electrical energy of resistive, inductive or combination loads comprising the steps of: (a) applying electrical energy to a circuit comprising of one or more of a resistive, inductive or combination loads, and a duty cycle controller having a first zero switch and a second zero switch connected to a reference controller and a drop out switch, the reference controller continuously connected to a line voltage, (b) switching off the current to the load when the reference controller determines that the line voltage is within a first predetermined threshold range, the first predetermined threshold range being associated with electrical energy that is not useful for the load to achieve a predetermined objective, and (c) switching on current to the load with the reference controller determines that the line voltage is within a second predetermined threshold range, the second predetermined threshold range being associated with electrical energy that is useful for the load to achieve the predetermined objective.

A further aspect of the subject matter disclosed herein provides for a system wherein consumption of electrical energy in resistive, inductive or combination loads is reduced, said system comprising: a duty cycle controller having a first zero switch and a second zero switch connected to a reference controller and a drop out switch, the reference controller continuously connected to a line voltage, wherein the duty cycle controller is configured to switch off the current to the load when the reference controller determines that the line voltage is within a first predetermined threshold range and switch on current to the load when the reference controller determines that the line voltage is within a second predetermined threshold range, the first predetermined threshold range associated with electrical energy that is not useful for the load to achieve a predetermined objective and the second predetermined threshold range associated with electrical energy that is useful for the load to achieve the predetermined objective.

In one aspect, the subject matter disclosed herein provides a reference controller that includes a reference voltage setting device. The reference voltage setting device is, in some such aspects, a zener diode. In some aspects, the reference controller may be fixed or variable.

A further aspect of the subject matter disclosed herein, provides for a method of reducing transmission of electrical energy to one or more loads that does not materially contribute to a predetermined objective of the one or more loads, the method comprising the steps of switching off electrical energy supplied to the one or more loads when one or more characteristics of the electrical energy reaches one of any number of predetermined first threshold points; switching the electrical energy on when the one or more characteristics of the electrical energy reaches one of any number of predetermined one or more second threshold points; and repeating, wherein the electrical energy transmitted between a particular pair of first and second thresholds is associated with a reduced contribution to achieving the predetermined objective.

A further aspect of the subject matter disclosed herein, provides for a method of controlling a system or device for reducing electrical energy to one or more loads that does not materially contribute to a predetermined objective of the one or more loads, wherein the method comprises the steps of: (1) switching off electrical energy supplied to the one or more loads when a characteristic of the electrical energy reaches one of any number of predetermined first threshold points; switching the electrical energy on when the characteristic of the electrical energy reaches one of any number of predetermined one or more second threshold points; and repeating, wherein the electrical energy transmitted between a particular pair of first and second thresholds points is associated with a lower contribution to achieving the predetermined objective; (2) measuring one or more sensed characteristics of the one or more loads that is indicative of whether or not the predetermined objective is being met; (3) adjusting one or more of the first and second threshold points to either (a) further reduce the consumption of electrical energy by the one or more loads if the one or more sensed characteristic indicates that the predetermined objective is being met, or (b) increase the consumption of electricity by the one or more loads if the characteristic indicates that the objective is not being met; and (4) repeating steps (2) and (3). Steps (2) to (4) are, in some aspects, carried out in parallel to step (1).

In other aspects, the subject matter disclosed herein provides for a control system that is configured to adjust one or more first and second threshold points for switching the transmission on and off to maximize the reduction of consumed electrical energy and/or minimize the impact on the load achieving the predetermined objective. The control system can be configured for manual or programmable control of positive and negative threshold values. The control system can include threshold control means that are associated with fixed, variable or digital triggering for optimized, constant, or variable control or for setting a threshold point.

In some aspects, the subject matter disclosed herein may include a reference controller comprising threshold means for manual or programmed control of positive and negative threshold voltages. The threshold control means include fixed, variable or digital triggering for constant control or for setting a threshold point. The reference controller may be continuously or intermittently connected to a line voltage.

In some aspects, the subject matter disclosed herein provides for a control system that, inter alia, determines whether the one or more associated loads are achieving a predetermined objective and, based on this determination, adjusts the timing for switching and/or the threshold points for switching.

In aspects, there is provided a method of reducing consumption of electrical energy by one or more loads, the method comprising the steps of: a) switching off the electrical energy to the one or more loads when a characteristic of the electrical energy equals a predetermined first threshold point; b.) switching on the electrical energy to the one or more loads when a characteristic of the electrical energy equals a predetermined second threshold point; and c.) repeating steps a) and b); wherein the electrical energy between the predetermined first and second threshold points is associated with a reduced contribution in achieving a predetermined objective of the one or more loads.

In other aspects, there is provided a method of optimizing reduction in consumption of electrical energy by one or more loads, the method comprising the steps of: a.) switching off the electrical energy to the one or more loads when a characteristic of the electrical energy is between a predetermined first threshold point and a predetermined second threshold point, wherein the electrical energy between the predetermined first and second threshold points is associated with a reduced contribution in achieving a predetermined objective of the one or more loads; b.) determining one or more sensed characteristics of the one or more loads indicative of whether or not the predetermined objective is being met; and adjusting the predetermined first and second threshold points to either, (i) reduce the consumption of electrical energy by the one or more loads if the predetermined objective is being met; or (ii) increase the consumption of electrical energy by the one or more loads if the predetermined objective is not being met.

In further other aspects, there is provided a system for reducing consumption of electrical energy by one or more loads, the system comprising a device coupled with an electrical energy source and the one or more loads, the device configured to: a.) switch off the electrical energy to the one or more loads when a characteristic of the electrical energy equals a predetermined first threshold point; b.) switch on the electrical energy to the one or more loads when a characteristic of the electrical energy equals a predetermined second threshold point; and c.) repeat steps a) and b); wherein the electrical energy between the predetermined first and second threshold points is associated with a reduced contribution in achieving a predetermined objective of the one or more loads.

In further other aspects, there is provided a system for optimizing reduction in consumption of electrical energy by one or more loads, the system comprising: a.) a device coupled with an electrical energy source and the one or more loads, the device configured to switch off the electrical energy to the one or more loads when a characteristic of the electrical energy is between a predetermined first threshold point and a predetermined second threshold point, wherein the electrical energy between the predetermined first and second threshold points is associated with a reduced contribution in achieving a predetermined objective of the one or more loads; b.) one or more sensing elements coupled with the one or more loads, the one or more sensing elements configured to determine one or more sensed characteristics indicative of whether or not the predetermined objective is being met; and c.) a controller in operative communication with the device, the one or more sensing elements and the one or more loads, the controller configured to adjust the predetermined first and second threshold points to either, (i) reduce the consumption of electrical energy by the one or more loads if the predetermined objective is being met; or (ii) increase the consumption of electrical energy by the one or more loads if the predetermined objective is not being met.

In further other aspects, there is provided a device for reducing consumption of electrical energy by one or more loads, the device comprising a first zero switch and a second zero switch that are in operative connection with a reference controller, which is continuously connected to an electrical energy source, the device configured to: a.) switch off the electrical energy to the one or more loads when a characteristic of the electrical energy equals a predetermined first threshold point; b.) switch on the electrical energy to the one or more loads when a characteristic of the electrical energy equals a predetermined second threshold point; and c.) repeat steps a) and b); wherein the electrical energy between the predetermined first and second threshold points is associated with a reduced contribution in achieving a predetermined objective of the one or more loads.

In further other aspects, there is provided a controller for optimizing reduction in consumption of electrical energy by one or more loads, the controller comprising one or more processors, the one or more processors in operative communication with a device and with one or more sensing elements of the one or more loads, the one or more processors configured to: a.) control the device to switch off the electrical energy to the one or more loads when a characteristic of the electrical energy is between a predetermined first threshold point and a predetermined second threshold point, wherein the electrical energy between the predetermined first and second threshold points is associated with a reduced contribution in achieving a predetermined objective of the one or more loads; b.) receive one or more sensed characteristics from one or more sensing elements indicative of whether or not the predetermined objective is being met; and c.) further control the device to adjust the predetermined first and second threshold points to either, (i) reduce the consumption of electrical energy by the one or more loads if the predetermined objective is being met; or (ii) increase the consumption of electrical energy by the one or more loads if the predetermined objective is not being met.

In further other aspects, there is provided a device for reducing the consumption of electrical energy of resistive, inductive or combination loads comprising: a duty cycle controller having two zero switches in line with a reference controller for connection across opposite sides of a line voltage, the two zero switches include a positive zero switch and a negative zero switch. The zero switches are gated power switches.

In further other aspects, there is provided a device for reducing consumption of electrical energy by a load, the device comprising a first zero switch and a second zero switch that are in operative connection with a reference controller, which is continuously connected to a source, the device configured to: a) apply the electrical energy from the source to the load until a reference threshold voltage is reached and then stop the electrical energy from the source to the load until the electrical energy reaches a preset reference level; and b) repeat for each zero crossing of the electrical energy; wherein the electrical energy between the reference threshold voltage and the preset reference level does not supply useful power to the load.

In further other aspects, there is provided a method for reducing the consumption of electrical energy of resistive, inductive or combination loads comprising: a duty cycle controller having a positive zero switch and a negative zero switch in line with a reference controller for connection across opposite sides of a line voltage.

In further other aspects, there is provided a system for reducing the consumption of electrical energy of resistive, inductive or combination loads comprising: a duty cycle controller having a positive zero switch and a negative zero switch in line with a reference controller for connection across opposite sides of a line voltage.

In further other aspects, there is provided a method of supplying electrical energy to a load from a source, the method comprising the steps of: a) applying the electrical energy from the source to the load until a reference threshold voltage is reached and then stopping the electrical energy from the source to the load until the electrical energy reaches a preset reference level; and b) repeating for each zero crossing of the electrical energy; wherein the electrical energy between the reference threshold voltage and the preset reference level does not supply useful power to the load.

In further other aspects, there is provided a system comprising a device in operative communication with a source and a load, the device configured to: a) apply electrical energy from the source to the load until a reference threshold voltage is reached and then stop the electrical energy from the source to the load until the electrical energy reaches a preset reference level; and b) repeat for each zero crossing of the electrical energy; wherein the electrical energy between the reference threshold voltage and the preset reference level does not supply useful power to the load.

In further other aspects, the reference controller includes a reference voltage setting device. The reference voltage setting device is a zener diode. The reference controller is fixed or variable.

In further other aspects, the reference controller has threshold control means for manual or programmed control of positive and negative threshold voltages. The threshold control means include fixed, variable or digital triggering for constant control or for setting a threshold level. The reference controller is continuously connected to a line voltage.

In further other aspects, there is provided a device for switching zero switches for restricting flow of an alternating current and controlling the amount of energy consumed by a load of the alternating current. An embodiment thereof includes a programmed peripheral interface micro-controller in line with a full wave rectifier for switching solid state switches. The peripheral interface controller is PC16F917. The full wave rectifier has over-current and over voltage protection.

In further other aspects, the micro-controller of the subject matter disclosed herein, in a chosen system and environment, interprets a signal from the full-wave rectifier to determine when to operate the solid state switches; to determine if a voltage present on a high-side of a transformer is unsuitable for a predetermined load; and to determine if the alternating current signal is either over or under frequency.

In further other aspects, there is provided a device for reducing the consumption of electrical energy of resistive, inductive or combination loads comprising: duty cycle controller having a first zero switch and a second zero switch connected to a reference controller and a drop out switch, the reference controller continuously connected to a line voltage.

In further other aspects, there is provided a a device for reducing the consumption of electrical energy of resistive, inductive or combination loads comprising: duty cycle controller having a first zero switch and a second zero switch connected to a reference controller and a threshold controller and a drop-out polarity switch, the reference controller continuously connected to a line for setting a voltage reference.

In further other aspects, there is provided a system for reducing the consumption of electrical energy of resistive, inductive or combination loads comprising the steps of applying direct AC voltage to a load until the voltage of a cycle reaches a required level before a drop-out switch triggers either a positive or negative switch up to a set point until an AC zero crossing occurs thereby allowing the cycle to repeat in an opposite polarity.

In further other aspects, there is provided a method for reducing the consumption of electrical energy of resistive, inductive or combination loads comprising the steps of applying direct AC voltage to a load until a reference threshold voltage is reached, turning on a first zero switch or a second zero switch and remaining on until a decreasing level reaches the preset reference level, repeating each cycle for each zero crossing of the AC voltage; no power is applied to any load Until a set threshold has been reached.

### BRIEF DESCRIPTION OF THE FIGURES

The subject matter disclosed herein, both as to its arrangement and method of operation, together with further aspects and advantages thereof, as would be understood by a person skilled in the art of the subject matter disclosed herein, may be best understood and otherwise become apparent by reference to the accompanying schematic and graphical representations in light of the brief but detailed description hereafter:

FIG. 1 is a schematic of one aspect of the subject matter disclosed herein showing an in-line duty cycle controller.

FIG. 2 is a schematic of a reference controller of one aspect of the subject matter disclosed herein.

FIG. 3 is a graphic representation of an exemplary sliced waveform and an unsliced waveform over one 360° cycle of a 120V AC voltage input in an aspect of the subject matter disclosed herein.

FIG. 4 is a graphic representation of a test procedure used for the duty cycle controller of one aspect of the subject matter disclosed herein.

FIG. 5 is a representation of an aspect of the subject matter disclosed herein showing a PIC micro-controller with a source and load attached thereto.

FIG. 6 is a flow diagram of an aspect of the subject matter disclosed herein in regard to the PIC micro-controller of FIG. 5.

FIG. 7 is a block diagram of the “Run” program of FIG. 6, showing switching “on” and “off” of gates in relation to exceeded pick up voltage and below pick up voltage.

FIGS. 8A through 8E are representations of various different slicing schemes which may be associated with different predetermined objectives of alternative aspects of the subject matter disclosed herein.

FIG. 9 is a block diagram of the method of reducing non-contributing electrical energy to a load in accordance with some aspects of the subject matter disclosed herein.

FIG. 10 is a block diagram of the method of controlling some aspects of the subject matter disclosed herein.

FIGS. 11A and 113 are representations of different slicing schemes for electrical energy that is DC.

### DETAILED DESCRIPTION

The subject matter disclosed herein will now be described more fully with reference to the accompanying schematic and graphical representations in which representative aspects of the subject matter disclosed herein are shown. The subject matter disclosed herein may however be embodied and applied and used in different forms and should not be construed as being limited to the aspects set forth herein. Rather, these aspects are provided so that this application will be understood in illustration and brief explanation in order to convey the true scope of the subject matter disclosed herein to those skilled in the art. Some of the illustrations include detailed explanation of operation of the subject matter disclosed herein and as such should be limited thereto.

The subject matter described herein relates to devices, systems and methods that, inter alia, are configured to supply the electrical energy requirements for one or more electrical loads, including inductive, resistive, capacitive, and combination loads, by eliminating or reducing the transfer of electrical energy to the load that does not substantially contribute to a predetermined objective of the load, while permitting the transfer of electrical energy that does contribute to the predetermined objective. In some aspects, it can be utilized in any inductive, resistive, or combination electrical devices that consume electricity, including in direct current (“DC”) or alternating current (“AC”) applications. In aspects, a characteristic of the electrical energy may refer to current or voltage. A characteristic of the electrical energy may also refer to resistance through a resistor, inductance through an inductor, capacitance through a capacitor or any combinations thereof. All of which may be obtained using current or voltage of an electrical signal. In aspects, a characteristic of the electrical energy may refer to power. A characteristic of the electrical energy may refer to any characteristic of the electrical energy that a worker skilled in the art would use as threshold points. In aspects, the electrical energy may be alternating current or direct current

Generally speaking, the subject matter herein relates to methods, systems and devices in which electrical energy is transmitted to electrical loads. Electricity is commonly transmitted from a generation facility to the location of consumption as AC, and characterized by transmission as a sinusoidal cycle or signal. In a typical AC electrical cycle, the current and voltage changes direction and polarity according to the sinusoidal cycle. Some aspects of the subject matter disclosed herein are configured to switch a circuit on or off during portions of the associated AC sine wave in which the supplied electricity would not contribute, or in some aspects, substantially contribute, to a predetermined objective of an electrical load. In some aspects, this predetermined objective may be to reduce the amount of electricity consumed by a load, without any reduction (or in some aspects an appreciable or material reduction) in the performance of that load. Other predetermined objectives may include the pre-heating of a light bulb filament prior to supplying light-inducing current in order to extend the life expectancy of the bulb.

In addition, as a person skilled in the art of the instantly disclosed subject matter would recognize, an AC electrical signal can also be characterized according to its “mode” or “phase”, as single-phase, dual-phase, tri-phase, multi-phase, or as any other mode or phase known in the art. In some aspects, the subject matter disclosed herein is configured to be compatible with any such phase at any given time without any electrical or mechanical changes to the applicable systems or devices. In other words, a device or system that is operative in accordance with the subject matter disclosed herein can operate, without any further manipulation or adjustment, to accept a power source in any phase or mode and it will produce the desired effect (that is, to reduce or eliminate electrical energy that does not contribute to the objective or objectives of an associated load while transmitting the electrical energy that does contribute to such objective or objectives).

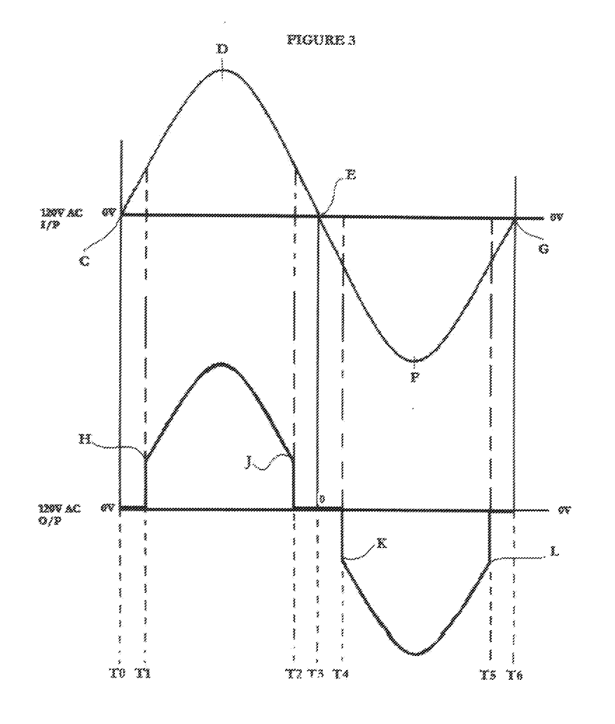

The transmission of AC is characterized by a current that alternates in both voltage and direction of current flow over time, as shown in FIG. 2. In certain aspects of the subject matter disclosed herein, there is provided devices, methods and systems that switch transmitted electricity on and off as the current reaches certain threshold levels during the cycle of a sinusoidal cycle. These threshold levels may represent, in some aspects, an amount of current flow that, as it approaches or moves beyond the zero point, is too insignificant to provide useful levels of electricity that can assist a particular electrical load in producing its desired effect. Exemplary threshold levels are indicated by the dotted lines in FIG. 2 at times T₀, T₁, T₂, T₃, T₄, and T₅, and the resulting cycle of electrical energy provided to the devices is also shown by the lower curve that is characterized by step changes in which the current steps from the current at the threshold level to a current of zero or vice versa. Aspects of the subject matter disclosed herein are configured to switch off the transfer of electricity when levels of electrical energy below or above these threshold levels may not provide electrical energy that is useful in producing a predetermined objective. Such predetermined objectives may include in some aspects, but are not limited to, the creation of light in a light bulb, heat in a light bulb, motive force or work in a motor, emission of EMI or harmonics or other interference. The term interference will be deemed herein to include EMI, RFI, harmonic interference, noise, inductance effects, voltage spikes or drops, or any other interference known to those skilled in the art. In aspects, predetermined objective may refer to any desired output of a load.

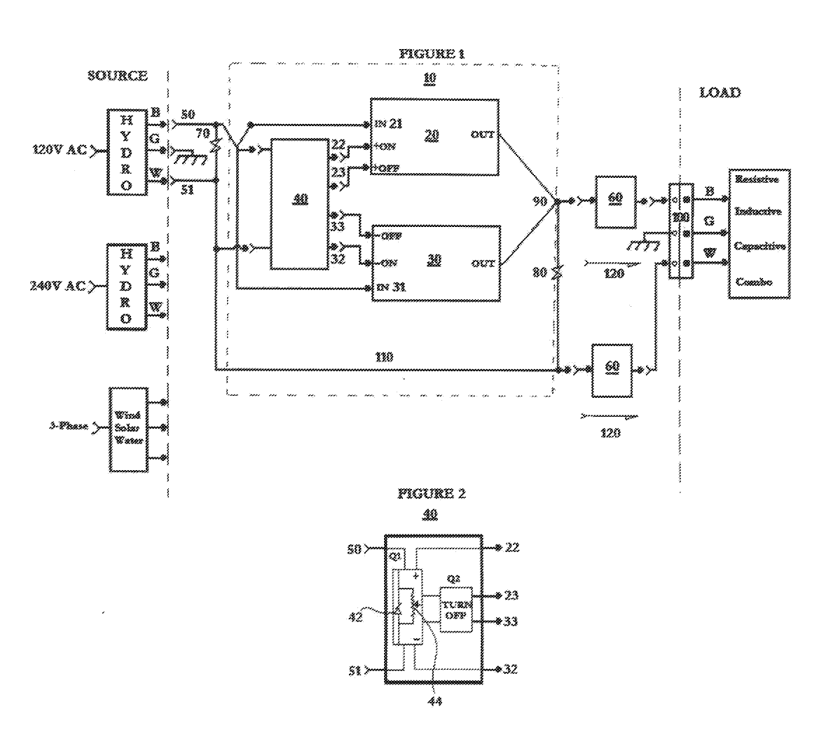

In the exemplary sine curve shown in FIG. 2, which may exemplify an AC transmission of electrical power from a power source to a load via an aspect of the subject matter disclosed herein, the current is switched off between times at which the threshold points are reached and therefore no current is supplied to the electrical load in question. Since the removed, or “sliced” portions of current do not provide energy that contribute to an objective of a given electrical load, for example, in causing an incandescent light bulb to provide light or cause an inductive motor to provide motive force, there are significant savings of electrical energy without any decrease in performance or a material or appreciable decrease in performance. As is apparent from viewing the curves in FIG. 2, there is reduced consumption of electrical power in loads using a “sliced” sine wave (the bottom wave in FIG. 1) as compared to a normal wave (the top wave in FIG. 2) but there is no associated reduction in output from the associated load in achieving its predetermined objective. In some aspects, as the threshold level approaches the peak of the sine wave (either the minimum or the maximum, depending on the direction of current), this consumption is reduced further, although at some point the threshold may begin to impact the amount of useful, or contributing, electrical energy that is transmitted to the load (or not transmitted to the load, as the case may be).

Aspects of the subject matter disclosed herein are configured to switch the current off and on at the threshold points to achieve a predetermined objective. Although discussed in further detail below, these objectives may include the regulation of a emission levels of light from a light bulb, regulation of emission levels of heat from a resistive element (including a resistive heater or a light bulb filament), regulation of emission levels of interference from a load, or a predetermined or optimal combination of two or more of these or other objectives.

Some aspects accordingly result in the efficient use of electrical energy since they do not permit the supply of energy that is incapable of being used to provide the predetermined objective. For example, the low levels of current that are transmitted to a light bulb as the AC approaches zero current are typically not enough to create light, but rather only create heat. By turning the electrical switch off during this time, there is little to no effect on the amount of light emitted, but the amount of energy consumed is reduced. Similarly, in an inductive motor, the lower amounts of current mostly produce heat and do not create motive force, torque or power. For example, testing of aspects of the subject matter disclosed herein as applied to incandescent light bulbs and inductive motors, results have shown that as the consumption of electrical energy is reduced by “slicing” the sine wave, in other words, switching the current on and off at pre-determined threshold levels of electrical current during the sine wave, a marked reduction in consumption of electricity can be achieved with little or no reduction in performance.

It has been observed in other applications that the use of switching technologies to abruptly, or in a step-wise fashion, switch the flow of electricity on or off may sometimes cause various forms of radio frequency (or electromagnetic) interference, or similar kinds of emissions or interference (as stated above, this term is intended to include the effects of harmonics, or changes to the sine wave signal due to the inductance of a circuit, sometimes measured or characterized as a change in “power factor”). This is sometimes observed in both the stepping-up from zero at a first threshold, but also at the point of stepping down of the current to zero during transmission. The stepping-up and stepping-down may cause different levels and/or different types of interference. Differences in interference levels may also be observed due to differences in where they occur on a particular sine wave. The effects of the emissions or interference are generally reduced as the current or voltage level at which the stepping occurs, decreases or approaches zero. In many aspects of the subject matter disclosed herein, a significant increase in efficiency (i.e. reduction of consumed associated with no decrease of performance of the load in achieving its predetermined objective) can be effected even when the threshold levels are maintained at very low current levels. In many aspects of the subject matter disclosed herein, levels of such emissions, interference or harmonics are further controlled or regulated by, for example, using different or improved components, switching configurations, timing, threshold/slicing patterns, threshold trigger points (i.e. purely time-based, purely current-based, or a combination thereof). It should also be noted that in some aspects, the emissions or interference are generally unwanted, but can be permitted at varying levels as an operating parameter itself (i.e. a predetermined objective, or component thereof), or in optimizing other operating parameters (i.e. efficiency, power output, pre-heating, etc.).

In other aspects of the subject matter disclosed herein, the threshold levels for “slicing” the electrical energy signal, for example a sine wave, may be changed depending on factors such as whether the current is increasing or decreasing (i.e. at the front or the rear of the wave). In addition, this adaptation of threshold level may be used to account for, in addition to efficiency, emissions, or interference, as well as other operating parameters.

In some aspects, the subject matter disclosed herein may manifest itself as circuit configuration which (a) measures the current being transmitted to the device, (b) determines when the current or characteristic thereof reaches a pre-determined level, (c) closes a switch on the circuit, thereby permitting transmission of the electricity, (d) determines when the current or characteristic thereof reaches a second pre-determined level, (e) opens a switch, thereby ceasing transmission of the electricity, and (f) repeating over multiple cycles of the sine wave and/or within a cycle.

In some aspects, the subject matter disclosed herein may also integrate software with the aforementioned hardware that can be used for implementing various control algorithms that may, inter alia, cause the elements and devices of a given implementation to “slice” an electrical transmission appropriately at pre-determined, constant, or variable threshold points. In some aspects, the adaptation of the threshold points discussed above may be achieved by various automated control systems of algorithms in such a way to optimize any of a number of different operating parameters of the load.

FIG. 1 shows a typical 120V AC source having a three wire system, the green wire G designated as the system ground, has no voltage present if connected properly, an aspect of the subject matter disclosed herein that is manifested as a Duty Control Cycle (DCC) 10, and a load. The white wire W, also at zero or at a very low voltage potential, is designated as the return (low or neutral wire) for the black wire B (hot, high wire). Measurements made between the return and ground wire in normal operation indicate no voltage potential. Unlike the green ground wire G, the return white wire W may have up to full 120V AC present on this wire due to a load fault. Accordingly, the black wire B supplies a positive and negative going peak AC voltage of 340AC peak-to-peak. The voltages that appear on the black wire B make use of the white wire W for its reference. The black wire B AC voltage swings both positive and negative relative to the white wire W zero reference. Three zeros (zero crossings) occur during every one complete cycle of the 120V AC or 240V AC. Similarly, in a 2-phase system, a 340V AC peak-to-peak nominal voltage AC is used to create the 240V AC with no current return line. The 340V AC measured across the black B and red R wires is the same as in the 120V AC which includes each wire having three zero crossings. However, the white wire W can be used to operate the zero crossings in the DCC.

The DCC 10 is both a current and voltage controller. An input voltage or hot side 50 of an AC line voltage is applied to the input 21 of a positive zero switch 20 and the input 31 of a positive zero switch 30. Zero switches used in industrial and commercial applications develop zero or minimal voltage when switching voltage or current “on” or “off”. The zero switches may be for example current-gated bipolar transistor (IGBT) switches known in the industry by many different names. In some aspects, the switches 20 are a form of gated power switch capable of handling the necessary current for the intended load, although other forms of switches are possible, including any other switch capable of performing the switching requirements as described herein of which a person skilled in the art would have knowledge.

An IGBT is a three-terminal power semiconductor device, noted for high efficiency and fast switching. It is designed to turn on and off rapidly and is often used to synthesize complex waveforms with pulse width modulation and low-pass filters. The IGBT combines the simple gate-drive characteristics of the MOSFETs with the high-current and low-saturation-voltage capability of bipolar transistors by combining an isolated gate FET for the control input, and a bipolar power transistor as a switch, in a single device. Of course, it will be understood by persons of ordinary skill in the art that alternate forms of switches, such as power FETs, MOSFETs, power transistors and the like, can be used in place of an IGBT.

As referred to above, the term zero switch may be used herein to identify any fully saturated device such as an IGBT. Although zero switches with varying capabilities and requirements may be used to achieve the functionalities described herein, in general the zero switch, when turned on, offers very low series resistance, which results in a very low voltage drop across the device causing minimal efficiency drop to the load. Most zero switch units have less than 1.0vd across the Source/Drain junction and some units even much less. Thus low heating and minimal heat-sinking may be required (in aspects requiring lower heat to achieve their objects). For high or very high power loads this becomes more important. An example used herein would be a FUJI 6MB130L which is a tri-phase 30 AMP zero switch. In an alternative aspect, there was used a higher powered 150 AMP BT operating at 75 AMPS which emitted minimal heat. Power FET's, MOSFET's, and other switches known to those skilled in the art may operate in a similar fashion and can therefore be used.

Input protection units are applied where necessary and additional protection from electrically generated sources may be applied by a fold-over current switch PT1 70. In some aspects, the DCC 10 would trip a breaker after PT1 70 went into operation. Similarly, a load failure in the DCC 10 output would be protected from damaging high back EMF's across the current controller zero switches 20 and 30 by a fold over current switch PT2 80. PT1 70 and PT2 80 may be used to protect the DCC 10 from unstable input sources. PT1 70 and PT2 80 generally operate only after a minimum over voltage occurs and do not, for example, provide a total short to the source supply of the DCC 10. Optionally, to further reduce switch transients and to reduce both radiated (RFI) and conducted electromagnetic interferences (EMI), power-line filters 60 may be used in the subject matter disclosed herein, in which the type of in-line filter would be determined by the DCC's 10 current capability. However, most low current loads would not require this in-line filter. The reduction in RFI, or other types of interference, in the aspect shown in FIG. 1, results from the fact that the switching occurs at low voltage levels. As a consequence, the amount of RFI, or other types of interference, is relatively minimal, and well within accepted standards.

Referring again to FIGS. 1 and 2, a reference controller 40 is connected across opposite sides (hot 50 and neutral 51) of the AC line voltage. The reference controller 40 supplies a fixed or variable reference switching source for both the positive zero switch 20 and the negative zero switch 30. Until the reference voltage (trigger level) is reached, the zero switches 20 and 30 remain off and without current. Although as described in respect of other aspects, the zero switches 20 and 30 may be on with current passing therethrough until the reference voltage is reached, at which time they are switched off. Contained within the reference controller 40 is a reference voltage setting device 42 (for example a zener diode, but for which other devices known to those in the art as providing similar functionality could be used) which sets the reference voltage (at a fixed or variable level, or as controlled by an optimizer or controller, not shown in the aspect of FIG. 1) for the circuitry of the reference controller 40 and the rest of the DCC 10. A reference controller/driver Q1 may appear in line with a drop-out controller/driver Q2 in the reference controller 40.

The reference voltage setting device is any device that is capable of managing or regulating the reference voltage. This could be as simple as a Zener diode, but may include other voltage regulating devices, as would be known to those skilled in the art, including, but not limited to, avalanche diodes, backward diodes, voltage regulators, transient voltage suppression diodes. Most micro-controllers, PIC's, etc. have built in reference sources and these sources act as a system reference and are adjusted accordingly.

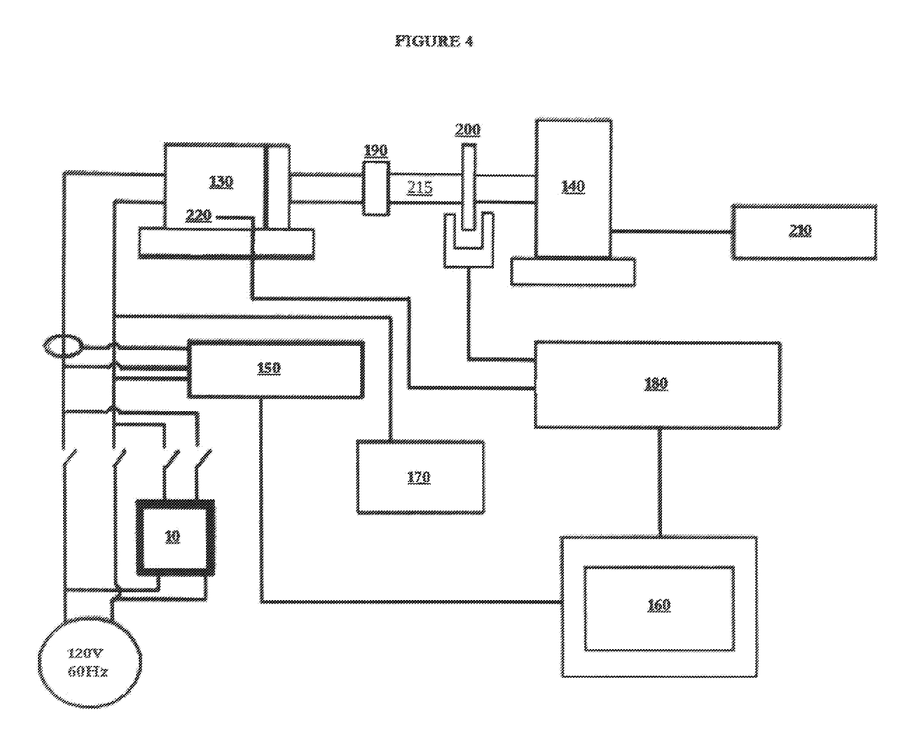

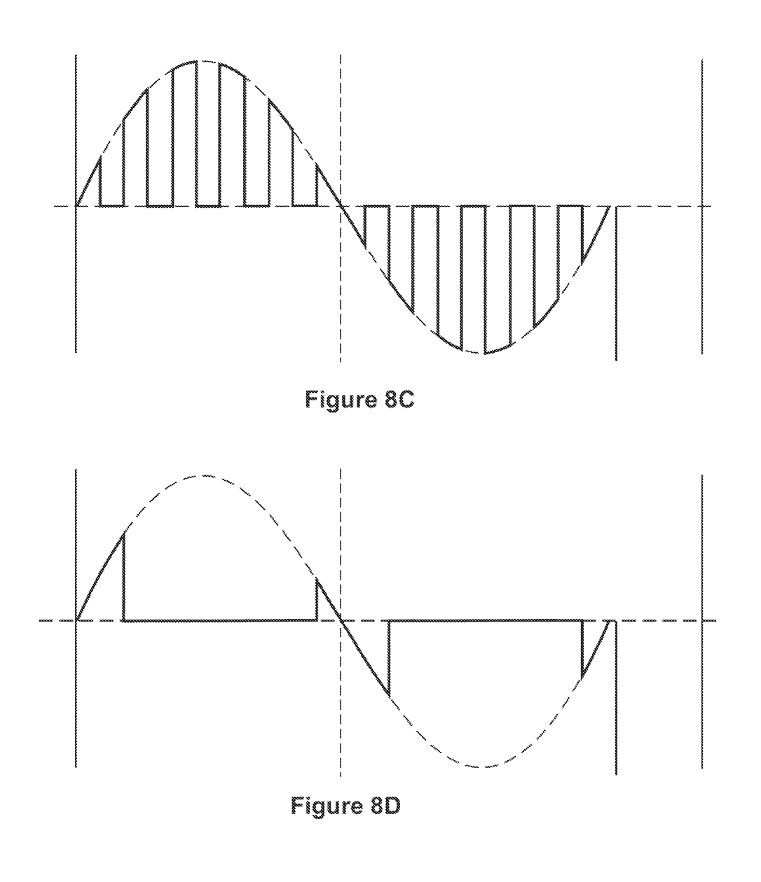

The reference controller 40 controls points H and J as shown in FIG. 3. In an aspect in which the sine wave manipulation shown in FIG. 3 is used to achieve the particular objective (in this case, maintaining a light bulb at the same brightness as it would have had with non-sliced power supply), the positive zero switch 20 is turned “on” and “off” due to the voltage levels supplied to gates 22 and 23 respectively. Similarly, the reference controller 40 controls the points K and L as shown in FIG. 2, in that the negative zero switch 30 is turned “on” and “off” due to the voltage levels supplied to gates 32 and 33 respectively. The duty cycle “on” to “off” time of the resulting sliced/chopped waveform may be determined for specific intended loads or may be fixed for general applications. Other sine wave manipulations are possible, including those shown in FIGS. 8A to 8E.

Included within the reference controller 40 (FIG. 2) is a threshold control means 44 which may be fixed or else variable under manual or programmable control to control the positive threshold values, at which the positive zero switch will turn “on” and “off”, and the negative threshold voltages, at which the negative zero switch will turn “on” and “off”. Accordingly, any suitable fixed, variable or digital triggering may be used for constant and/or optimizable control or to set the threshold level.

Referring further to FIG. 1, a DCC 10 of one aspect of the subject matter disclosed herein includes two zero switches, namely a positive zero switch 20 and a negative zero switch 30, along with a reference controller 40, applied to a source and a load. The positive set 22 and the negative set 32 are used to turn “on” the positive zero switch 20 and negative zero switch 30 on the increasing AC voltage level of positive edge H and negative edge K of the sine wave cycle of FIG. 3. Similarly, the positive drop-out 23 and the negative drop-out 33 are used to turn “off” the positive zero switch 20 and negative drop-out switch 30 on the decreasing AC voltage level of positive edge J and negative edge L of FIG. 3.

Referring to FIGS. 8A through 8E, different “slicing” or “chopping” schemes are shown. As described above, the positive and negative sets 22, 32 are used to respectively turn the positive and negative zero switches 20, 30 “on” and the positive and negative drop-outs 23, 33 are used to turn “off” the positive and negative zero switches 20, 30 at respective given “on” or “off” threshold points resulting in sliced sine waves as shown in FIGS. 8A through 8E. Of course, it will be recognized that any pattern of sine wave and any slicing scheme can be achieved using the methods, systems and devices described herein and the subject matter disclosed herein is not limited to those shown in FIGS. 3, 8A, 8B, 8C, 8D and 8E. The slicing schemes shown in those Figures relate to a given pre-determined objective as follows (although other objectives not described herein would be possible):

TABLE 1
Example Predetermined Objectives for Slicing Schemes Shown in
FIGS. 3, 8A-E.

| FIG. | Possible Predetermined Objective |
|---|---|
| 3 | Maintained load output (i.e. light bulb brightness, motor power, |
| | resistive heating) as compared to non-sliced loads |
| 8B | Life-prolonging pre-heating cycle in incandescent or fluorescent |
| | light bulb to be run before applying light-inducing electrical |
| | energy to the light source |
| 8C | Maintain ionization threshold in fluorescent light |
| 8D | Same as 8B, but objective also includes management of |
| | interference (since drop-out, i.e. step-down, generally induces |
| | greater amount of interference than from the voltage increase |
| | from the set, i.e. step-up of voltage) |
| 8E | Same as 3, but objective also includes management of |
| | interference |

Returning to FIG. 1, the outputs of the zero switches 20 and 30 are combined at point 90 and are sent to the output socket 100 directly via a filter bypass 120 or, in some aspects, via the line filter 60 for optional control of interference (such as EMI emissions or harmonics). Similarly, the return line 110 may be connected directly to the output socket 100 or via the line filter 60. Load protection can be applied directly via a plug to a socket, as in, for example, a standard wall outlet (not shown). However, the majority of applications using the DCC 10 would have different load connected directly to the DCC 10 or have the DCC 10 effectively as a direct source. In some aspects, a device comprising the DCC 10 may be manufactured directly to a load input source or as a separate device that may be used as an intermediate that can be implemented at the time of manufacture or any time thereafter. The DCC 10 used for 240V AC operation may use two 120V AC DCC's 10, one either side of the line inputs.

FIG. 3 depicts one full cycle of an exemplary sine wave at point C to E to G, equaling 360 degrees. In this exemplary sine wave, the objective may be, for example, to maintain at reduced consumption of electrical power a normal brightness of an incandescent light bulb, an ionization threshold of a fluorescent light bulb, or the full speed/work level of a motor by switching off the electrical current when the current would not contribute, would interfere with, or be surplus to any of these objectives. The zero point for the black wire occurs at points C, E and G. The voltage referenced to the white wire 51 or “return” in normal operation is at zero volts. From the 120V AC input sine wave depicted in FIG. 3, the positive peak voltage at D also reaches a peak value of 170V AC. Accordingly, a peak-to-peak (P/P) value of 340V AC can be measured on the black wire 50. These same levels apply to the 240V AC input and multi-phase input sources. The P/P voltage for a 240V AC input is 340V AC, the same as the 120V AC input source.

The duration of the sine wave cycle shown in FIG. 3 is 16.67 milliseconds for a frequency of 60 Hz. With reference to FIG. 3, T₀ refers to the start of the AC cycle; T₁ refers to the 1^{st} threshold (H); T₂ refers to the 2^{nd} threshold (J); T₃ refers the end of the 1^{st} half cycle; T₄ refers to the 3^{rd} threshold (K); T₅ refers to the 4^{th} threshold (1); and T₆ refers to the end of the first full cycle. When applied through a light bulb, for example, the four threshold segments T₀-T₁, T₂-T₃, T₃-T₄ and T₅-T₆ can be substantially eliminated with no apparent effect on light bulb brightness. The “sliced” segments have been shown in experiments to reach over 25% of the AC duty cycle, thereby resulting in efficiency improvements based on the eliminated cycle percentage.

In other aspects, the desired objective may be different. This is described in additional detail below, and may include, for example, an objective of a “warm-up” period for an incandescent light bulb to increase the life span (since, as a person skilled in the art would recognize, the primary reason for “burn-out” of an incandescent light bulb comes from the fact that a cold filament is instantaneously exposed to the full voltage required for light emission), reducing electrical energy consumption or increasing life-span of a fluorescent bulb by maintaining an ionization threshold (the subject matter disclosed herein can be applied to ensure that only the ionization threshold is maintained since most fluorescent light bulbs run at a level much higher than said threshold resulting in a consumption of electricity that need not otherwise be consumed and/or reducing the lifespan of the light fixture), maintaining or regulation a colour “temperature” or intensity of an LED light (different portions of the sine wave provide different colour temperatures or intensities and control system can manage this at any given time to maintain or change such characteristics or account for changes of the output of these characteristics in an LED over time due to aging), and accounting for “aging” effects of an electrical load (as the level of non-contributing electrical energy relative to the contributing electrical energy may change over time, as will the load output, which can be compensated for by using different slicing schemes or profiles). The resulting sliced sine waves may appear different for such objectives

The AC cycle can be controlled with a fixed or variable reference controller. Each half cycle, positive or negative, will have, in the aspects shown in FIG. 2, two controlled areas for a total of four controlled areas per cycle. Because the switching at points H, J, K and L occur at relatively low voltage levels, interference and noise will be minimal. The voltage level at the time of switching the circuit “on” or “off” will have an effect on interference, noise, harmonics, etc. Accordingly, the thresholds at switching points H, J, K and L can be adjusted to ensure a reduced consumption of non-contributing electrical energy, while at the same time maintaining interference above or below required or predetermined levels, or within a particular range. Simultaneous regulation or these characteristics, and optimal regulation of both (i.e. transfer of non-contributing electrical energy and regulation of interference), may be one predetermined objective for a load in some aspects. Using the switching methods and devices disclosed herein, a significant reduction in non-contributing electrical energy, enabling the load to operate without any appreciable loss in output, can be achieved with both radiated and conducted emissions remaining below and complying with industry standards.

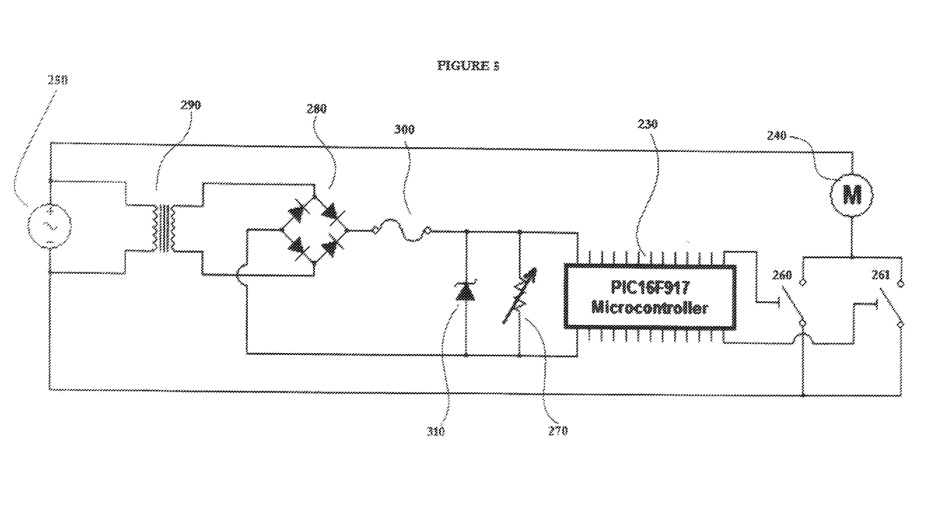

Referring to FIG. 4, for test purposes, a geared induction motor 130 of 120V, 60 Hz with a gear ratio of 34:1, was coupled to a HB-840 Hysteresis brake 140 to simulate a regulated load to the motor 130. The digital scope 170 was used to view the signal source. A Microvip 3 Harmonic and power analyzer 150 connected to a computer (PC) 160, was connected to the induction motor 130 to monitor the power consumption, A Data Acquisition Board 180 connected to the PC 160 was also connected to the induction motor to monitor the power consumption. Data was also collected from the rpm encoder 200 and temperature probe 220 situated about a drive shaft 215 to monitor temperature of the motor 130 and the rpm's.

The induction motor 130 was initially operated in normal power without employing the DCC 10 circuit. The load on the Hysteresis brake 140 was adjusted to draw about 33 W and this situation was maintained until the temperature of the motor 130 stabilized. Once the temperature was stabilized, the DCC 10 was put into the circuit. The DCC 10 was adjusted to decrease power to the induction motor 130 by 5% steps, and maintain this level until the temperature of the induction motor 130 stabilized. This procedure was repeated until 30% decrease in power was obtained.

Upon review of test data for the above aspect, it was evident that the power consumption decreased while maintaining the rpm value at approximately 51.7 rpm when the sine wave profile was sliced in accordance with FIG. 2. Moreover, from the test results, the temperature of the motor 130 had decreased indicating that less electrical power had been used. The test results provide a clear indication that the introduction of the DCC 10 gave the same mechanical work with less electrical power.

TABLE 2
Motor Test Results.
Test Results

| | | | Load/Load | |
|---|---|---|---|---|
| Circuit | RPM | Watts | Reduction % | Temperature |
| Standard | 51.7 | 33.6 | 100 | 40 |
| DCC | 51.7 | 33.4 | 0.59 | 39.5 |
| DCC | 51.7 | 31.5 | 6.6 | 39 |
| DCC | 51.6 | 30.3 | 10.8 | 38 |
| DCC | 51.6 | 29 | 15.8 | 38 |
| DCC | 51.6 | 27 | 24.4 | 37.4 |
| DCC | 51.4 | 24.8 | 35.4 | 36 |

The circuit used to achieve the above test results was also tested in a generator mode which also indicated the same basic results with a lower percentage gain. In the generator mode the induction units have more losses to overcome before generation of power can occur. In this mode, a (DC) motor was coupled on the other side of the Hysteresis Brake 140 acting as the prime mover, the brake 140 was turned off. The induction units were turned above synchronous speed engaging into generator mode. The test set-up information for FIG. 4 and the results shown on Table 1, include an induction Motor 130 Type U2615A-5, 115 volts 60 Hz 0.38 Amps; Magtrol Hysteresis Brake H-840 140; Magtrol Power Source 5210 210; Microvip 3 plus Harmonic and power analyzer 150; Digital scope INSTEK® GDS-1102 170; Data Acquisition USB 6330 180; Omron® optical Sensor; Omron® thermocouple; Raytek® heat gun; HP computer SOOOn 160; Tenma® 72-2050 multi meter; Blue Point® MT 139a Digital Tachometer. The DCC 10 parts include: Trias® X25783; Capacitor W683K MEF 250 6.8 picofarads; Capacitor W473K MEF 250 4.7 picofarads; Inductor and Potentiometer 250 kilo ohms.

The duty cycle controller 10 of one aspect of the subject matter disclosed herein may be used in reverse with a generator with the same type of efficiency as when used with a load as previously described. The portions of the AC cycle not supplying useful power to the loads would be removed in accordance with the methods and devices described herein. As such, an associated load would not need a DCC 10. However, if equipped with a DCC 10 at source and load, both units would synchronize and become transparent to each other and the threshold reference would determine which DCC 10 would become the operational DCC 10. Overall the simplicity of the DCC as used with a generator would be the same as the original DCC 10, which in turn would allow generating sites using fossil fuels, nuclear, wind, solar, water and others to reduce stress on their infrastructure and deliver greater power with no further changes.

It has been found that the DCC 10 of the subject matter disclosed herein may be used for direct current (DC) operation in a similar fashion as with AC operation. For instance, DCC 10 operates toward the lower voltage levels of the AC cycle. In direct current operation, the zero switches switched “on”, the load will be supplied electrical energy at the full DC current, and the circuit will not supply electrical energy with the output switched “off”. This permits the DCC, in this aspect, to generate a custom duty cycle depending on the (DC) loads. The use of greater (DC) voltage levels, switching noises will inevitably increase. When used for high efficiency chargers, such as for example, in charging electric car batteries, an improvement may be found even when used with switched power supplies.

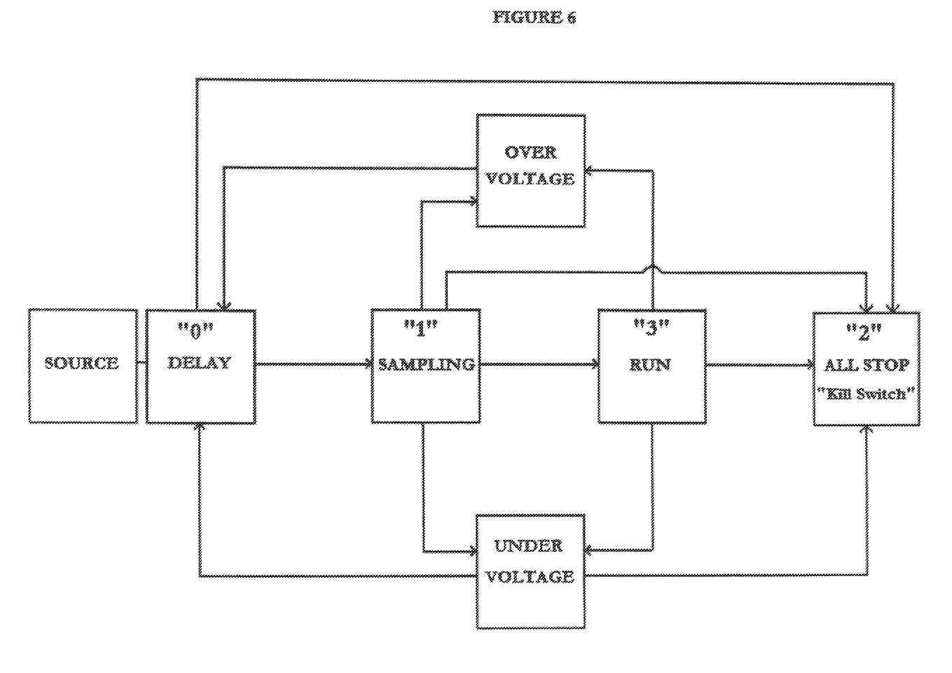

In an alternate aspect, there is provided a software and hardware version of the DCC 10 hereinafter referred to as 10A. Referring to FIGS. 5, 6 and 7, the concept of the DCC 10 as previously referred to, is applied in a dynamic switching of the zero switches with load control efficiencies. In this aspect, the software and hardware driven DCC 10A uses a Peripheral Interface Controller (PIC) 230, more specifically PIC16F917. Other controllers or microcontrollers can be used, as would be known to a person skilled in the art. The DCC 10A depicted in FIG. 5 is able to restrict the AC flow in a precise manner thereby controlling the amount of energy consumed by an AC load 240 at any given time and react to changes in load performance or output, which, for example, may be detected by a sensor. For example, a single-phase AC motor can be controlled by the hardware and software used for a 60 Hz AC signal 250 seen by the load. In one aspect, the DCC 10A has a full wave rectifier 280 with over-current and over-voltage protection. A PIC-based micro-controller 230 and software, in some aspects having solid state switches, GTO's or high speed solid state relays 260 and 261, may be used to control the DCC 10A when the AC voltage is permitted to reach the load 240. The full-wave rectifier 280 is used to modify the AC signal such that the PIC's 230 Analog to Digital Converters (ADC's) can accept the output of the rectifier 280 which is then used by the PIC 230 to determine when to operate the solid state switches 260 and 261.

The full-wave rectifier circuit 280 may produce a 4V_{Peak} signal (when 120V_{RMS}AC is presented to the high side of the transformer 290 which may be tuned using a variable resistor 270 in parallel to the micro-controller's input. Accordingly, the PIC-based microcontroller 230 interprets the signal from the full-wave rectifier 280 to determine (a) when to operate the solid state switches 260 and 261; (b) if the voltage present on the high-side of the transformer 290 is unsuitable for the load 240, meaning that it does not contribute to achieving the predetermined objective, and which can be determined ahead of time or during operation in real-time (this can be customized); and (c) if the AC signal is either over or under frequency. The reference controller includes both the variable resistor 270 and the reference voltage setting diode 310, which may be for example a Zener diode. Fuse 300 provides added protection on the line.

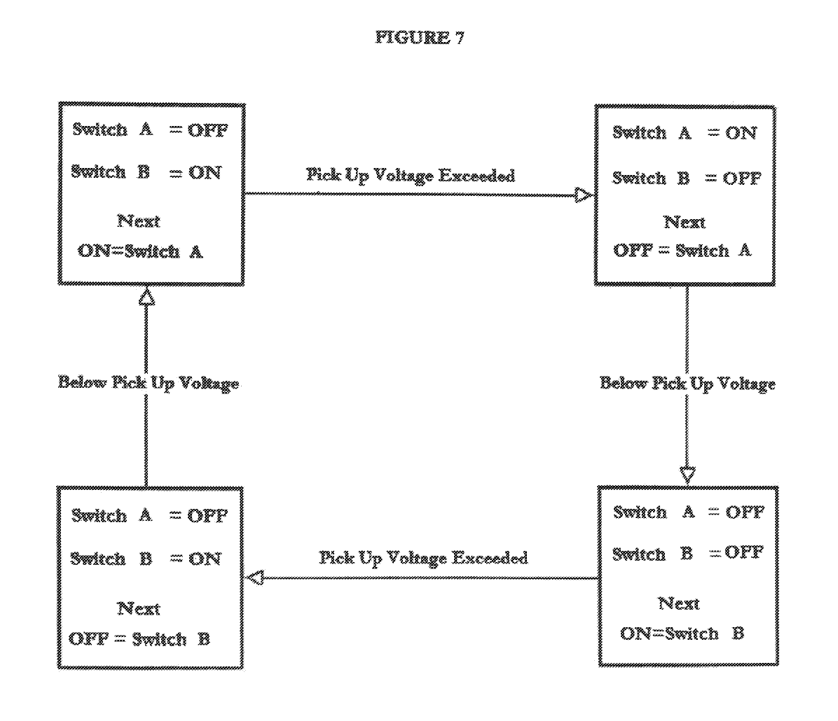

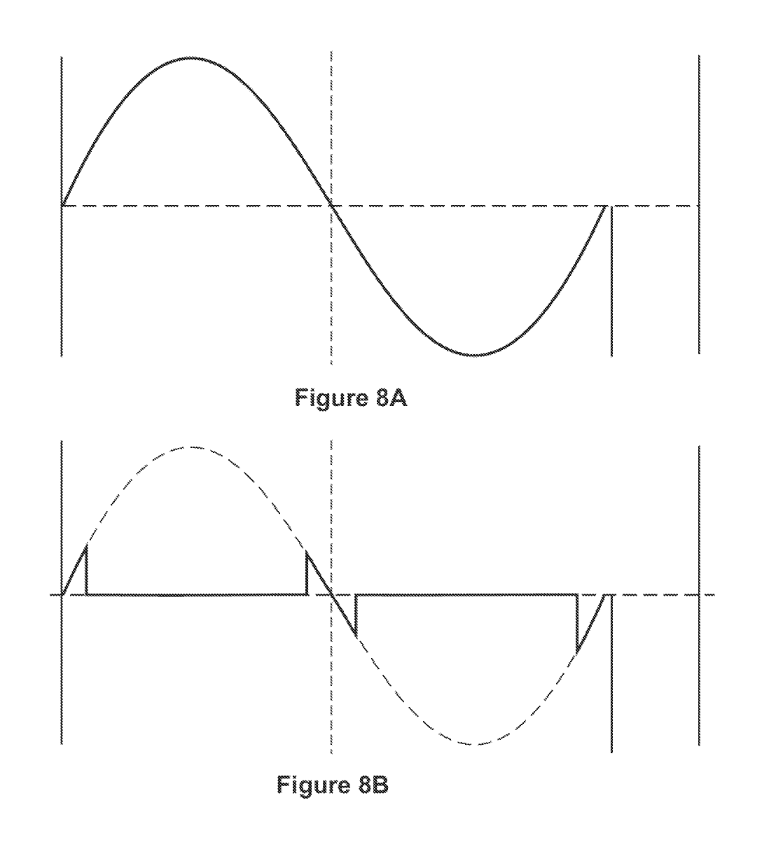

Referring further to FIGS. 6 and 7, the speed of execution and finer degree of control over the micro-controller hardware requires a high-level PIC assembly program thereby providing software configurable tolerances including a maximum voltage that the load can tolerate and a minimum voltage required by the load. If these tolerances are not met, the PIC based micro-controller 230 turns off the AC power to the load in less than 0.3 milliseconds. From the input of the source, the time Delay “0” is provided which acts essentially as a fail-safe system. The time delay “0” will verify whether the incoming source is stable. Accordingly, there is provided configurable turn “on/turn “off” voltages for the solid-state switches; and configurable over/under frequency detection. The over voltage and over/under frequency protection can be disabled in the event that the load is to be “run-to-failure”; and the software driven kill-switch “2” can cut the AC power to the load in less than 8j/s. If there is a change in the amount of AC permitted to reach the load (load requirements) or change in max/mm voltage tolerances, etc., the digital system is adaptable to accommodate for any such change to compensate for any anomalies of the motor.

Referring to FIG. 7, the “Run” program determines the switching “on” and “off” of the threshold switches with regard to the exceeded pick up voltage and below pick up voltage set by the threshold control means. These may be fixed or else variable to control the positive threshold voltages at which point the positive zero switch A will turn “on” and “off”, and the negative threshold voltages at which the negative zero switch B will turn “on” and “off.” Accordingly, any suitable fixed, variable or digital triggering may be used for constant control or to set the threshold level.

The switching procedure as applied in the DCC 10A was previously shown from FIGS. 1 and 2 in the “analog” version of the DCC WA. FIG. 7 shows the sequence of switching of switches 260 (switch “A”) and 261 (switch “B”) over the course of one full AC cycle. The positive zero switch is turned “on” and “off according to the voltage levels supplied by the PIC Micro-controller. Similarly, the “Run” program controls the negative zero switch, turning it “on” and “off” according to voltage levels supplied by the PIC Microcontroller. The duty cycle “on” to “off time of the resulting sliced/chopped waveform may be determined for specific intended loads, may be fixed for general applications, and/or for any, predetermined objective that may apply thereto.

As used herein, the term “slicing scheme” refers to the number and location of threshold points for when the circuit is turned on and off during an electrical signal. Examples of slicing schemes for an AC current are shown in FIGS. 3 and 8A through 8E. The slicing scheme established by particular threshold points can be constant across successive sine waves, or can change over time or from wave to wave, positive or negative. Moreover, the threshold points for turning the circuit “on” and “off”, respectively grouped as threshold pairs (which bound portions of the electrical signal in which the circuit is switched off), can be triggered by a current and/or voltage of a the source as it changes over time, or it can be triggered by time (i.e., every 0.3 milliseconds, which could, for example, correspond to a point just past the zero point of each wave in a sine wave signal, or every second wave, or just the positive half cycles, to name a few examples). It can also be triggered by a combination of time and current and/or voltage levels.

The duty cycle control device of some aspects of the subject matter disclosed herein can take the form of unit shapes and sizes of varied dimensions to be used as add-on or built-in fixtures applied in conventional home products and applications including, but not limited do, home electrical heating of 25.0 KW or on the commercial 3-phase systems.

In some aspects of the subject matter disclosed herein, the predetermined load objective of the reduction of power consumption with no resulting loss of power function provides for environmentally-friendly benefits and reduced costs of manufacture.

In one particular exemplary aspect, there is provided a 50AMP controller that can optionally be palm size and the device and method of use within the system can be used to bolster energy star ratings by achieving lower energy usage with no reduction in load output. Moreover, the subject matter disclosed herein can provide for viable light bulbs to produce the same constant lumen output after threshold levels are removed, thereby providing a direct bulb efficiency without having to change the bulb. In effect, and as an example only, there is a clear and apparent useful application in the field of incandescent lighting, for instance with high quality tungsten filamentous light bulbs as opposed to using the inefficient environmentally unfriendly cfl bulbs. It should be noted, however, that the subject matter disclosed herein can be applied in respect of fluorescent (or CFL bulbs) to consume less electrical energy and provide the same light output. Moreover, if the predetermined objective is to provide a pre-heating cycle that will extend the lifetime of a tungsten filament and not cause the filament to emit light during such cycle, then the correct slicing scheme can be used to achieve such an objective.

With respect to the above description, it is to be realized that the optimum duty cycle (on to off time) of the subject matter disclosed herein can be determined by specific loads or may be fixed for general applications. It is to be further realized that variations in application of the subject matter disclosed herein may include many aspects of commercial and personal use.

Slicing schemes can be specifically adapted for different types of loads, which may have differing characteristics, advantages and disadvantages for which different predetermined objectives may be desirable. For example, compressors, microwave magnetrons, fluorescent lamps, light-emitting diodes (“LED”), resistance heaters, and so-called “smart” motors or lights. Each of these applications may have different predetermined objectives which may be desirable to a particular user, and achieving same may involve the use of different slicing schemes, which are achievable using the methods, systems and devices of the instantly disclosed subject matter.

Fluorescent lamps typically require a pre-heating period to achieve a sufficient ionization threshold. Once ionization has been achieved, the level of electrical current and/or voltage is usually higher, sometimes significantly higher, than the levels required to maintain the ionization threshold, leading to degradation of the fluorescent light source over time, including the light brightness and quality. Using a slicing scheme to remove portions of electrical current that do not contribute to maintaining the ionization threshold can be removed, thus both increasing the lifespan of the light bulb while providing the same light output, but also reducing the consumed electrical energy for the same light output. Moreover, the ambient temperature may affect the lighting characteristics and speed of pre-heating and/or light characteristics. Slicing schemes that are restricted to providing electrical energy that only contributes to the heating or the ionization of the light that is specifically adapted to account for different ambient temperatures is possible.

LED lights may be produce different levels or intensities of brightness and/or different colour “temperatures” based on currents and/or voltages associated with various portions of an AC sine wave. Accordingly, some slicing schemes may be used to achieve a lighting or other pre-determined objective associated with an LED light or group of LED lights. This may include achieving the same light brightness or colour temperature, but with reduced consumption of electrical energy, as would be emitted with a non-sliced AC sine wave cycle.

Since LED lights can also be used to generate an electrical signal based on the intensity of ambient light, the circuit can be used to communicate such sensed levels of ambient light during periods of the circuit being switched “off” by aspects of the subject matter disclosed herein and the slicing scheme, or alternatively the overall energy being transmitted, can be adjusted to increase or reduce the amount of light emitted by the LED when the circuit is switched “on” based on the levels of ambient light as determined by the lights themselves and communicated to the control system during “off” times by the circuitry itself. Other examples of using the circuit to communicate signals relating to the state of the load (or other states as sensed by the load or its peripheral devices) during periods of being switched “off” are discussed in further detail below.

The term “smart motors” may be used to refer to any motor that can sense a given characteristic or set of characteristics and then adjust performance of the motor based on said characteristic or set of characteristics. Smart motors can use various slicing schemes to achieve their objectives more easily, efficiently, or rapidly, for example.

As would be known to a person skilled in the art, the step-up in current and/or voltage as well as a step-down in current and/or voltage, as may be caused by the slicing from the sine wave signal of AC (or alternatively a DC current) in accordance with the subject matter disclosed herein, may cause a certain amount of interference (which, as discussed above, as used herein may include EMI, RFI, harmonics, noise, inductance effects, or other types of interference as known to a person skilled in the art). While some aspects of the subject matter disclosed herein may incorporate additional filters and/or methods for reducing interference, some slicing schemes may also be used in order to minimize or maximize (or otherwise optimize) interference. Since a step-up may cause different levels of interference than a step-down, some customized cycles may, for example, include a step-up that is larger or smaller in magnitude than the step-down to optimize the level of interference, depending on the predetermined objective in any given application of the subject matter disclosed herein. Examples of such a customized slicing scheme may be found in FIG. 8C or 8D. A step-up refers to a step change from zero (or low) current and/or voltage to a current and/or voltage that is higher in absolute value. In other words, as used herein, a step up refers to a similar type of change whether in the positive or negative portion of an AC sine wave; that is, from zero very low to a higher positive or negative current and/or voltage. Conversely, a step-down refers to a change from a positive or negative current and/or voltage to a zero or very low current and/or voltage. It does not necessarily refer to an actual direction of stepping, but rather to the relative change in the value of the current and/or voltage.

In some alternative aspects, a use of capacitors or other electrical components to divert, or otherwise capture or use in alternative ways, energy that is “sliced” from the electrical input using the instantly disclosed subject matter is provided for herein. Instead of simply switching the circuit “off” when an AC sine wave, for example, has been sliced, some aspects may provide for a diversion of that energy to an alternate device or load, or energy storage device. In aspects, one or more electrical energy diverting devices may provide for a diversion of the electrical energy, which has been sliced, to an alternate device or load or one or more energy storage devices. In aspects, the one or more electrical energy diverting devices may be part of the device that is used to slice the electrical energy or the duty cycle controller. In aspects, the one or more electrical energy diverting devices may be separate from the device that is used to slice the electrical energy or the duty cycle controller and may be operatively connected to the device that is used to slice the electrical energy or the duty cycle controller. For example, a capacitor or other electrical element may be used to condition or regulate the current so that it may otherwise contribute to the predetermined objective of the load, or that of another load. In other aspects, that portion of the AC sine wave may contribute to a different objective in another load and be diverted directly thereto, or thereto via one or more electronic elements (such as a capacitor) to regulate or condition the current. This may include the use of running 2-phase split capacitor motor as a single phase motor. In other aspects, the sliced electrical energy may be diverted to a battery or battery charger to store the diverted energy for later use in the same or different loads.

In some aspects, there is also provided a control system or a controller. The control system or controller may be one or many. Each duty cycle controller may be in operative communication with a controller or there may be one controller controlling the multiple duty cycle controllers. In aspects, a processor within the duty cycle controller may act as the controller. The controller may, based on one or more characteristics, adjust the threshold points for switching the circuit “on” or “off”. These characteristics can include the level of the load output, time, interference levels, ambient conditions, or other characteristics of the load or the environment. In one aspect, a first slicing scheme is engaged in which an output of the load is maintained at the same level as would be provided with a full (i.e. non-sliced) AC signal. The threshold points for such scheme could be adjusted to attempt to achieve an even greater efficiency, while maintaining the same load output, but as the threshold adjustments begin to affect the load output, the control system would detect such an effect and change the threshold points to those in which less contributing electrical energy was sliced. In such a way, for this aspect and this objective, an even more efficient load circuit could be achieved. This is an efficient way to find the most optimal threshold points for slicing in real time for a particular load (or group of loads), since optimal threshold points may be different from load to load, change over time for a particular load, change for a given load in light of different characteristics of the associated electricity source, changes in motor or other load output requirements (e.g. due to external assistance provided to treadmill motor), or change for a particular load given changes in the ambient conditions of the load (e.g. temperature). The control system maintains the threshold points to dynamically maintain the most optimal slicing scheme at all times.

Such a control system would comprise, in addition to the elements of various aspects of the subject matter identified herein, one or more sensing elements, one or more controller elements, and one or more actuator elements. Any or all of these may be combined into a single element or be distributed across multiple elements. The sensing element is any device capable of detecting and/or measuring the characteristics that indicate whether the predetermined objective is being achieved, and may include, but is not limited to a light meter, photovoltaic cell, torque meter, ammeter, voltmeter, etc. The sensing element may refer to any component, electrical or otherwise, referred to herein that measures some characteristic associated with the load, source or circuitry of the subject matter disclosed herein, as would be readily known to a person skilled in the art. For example, an aspect in which the load is a light, it could be a device to detect the intensity or colour of a light. The sensed one or more characteristics would be communicated to the control element, which would assess whether to implement a change in the threshold levels, if any, based on a predetermined algorithm associated with the control element. Changes in the threshold levels can be implemented by the actuator element (which may or may not be the control element). The control element may include any processor or microprocessor, including those disclosed herein, but may also include any other electrical component or set of components capable of receiving an input and, based thereon, providing an output. Other alternatives for the control, sensing and actuator elements could be used, as would be readily understood by one skilled in the art, without departing from the scope and spirit of the components specifically disclosed herein.

Changes in the one or more characteristics can be communicated to the control means and/or the actuator means wirelessly, via a separate wired communication system, or via the circuit itself during periods in which the circuit is switched “off” (i.e. sliced).

The control system can be used in conjunction with, and for control of, loads, including resistive, inductive, and capacitive and all combinations thereof from the smallest single load to massive industrial loads. A study of the Hydro Source (the so called 120V AC wall outlet source) was completed and results for 120V AC, 240V AC single or multiphase and were all found compatible with the instantly disclosed subject matter. In depth analysis and measurements have created “new” alternate VIP characteristics (VIP voltage-current-phase). This variation has made for a more suitable method to define and use the Hydro Source. The voltage EG is associated more closely with direct power and determines the action required to increase efficiency and ultimately reduce power consumption.

In one aspect, a control system can achieve this power consumption reduction and efficiency gain. In some aspects, the control system may be efficient in operation so as not to take away from the load(s), and the action of the control system can be analogous to the common household on/off wall switch. When such a control system causes the system to be turned on, it is considered to be “fully on” (in other words, no power is dissipated across the switch). In like manner when a wall switch is turned off, it is considered to be “fully off”, in other words 100% efficient. Current technology has allowed solid state switches to very nearly emulate the wall switch and provide efficiencies of the order of 98% and more. This electronic switch may exceed the capability of the wall switch and is able to perform multiple switching during a single sine wave cycle. In some aspects, the control system comprises an electronic switch which may be capable of the following: high thru-put, low substrate heating, long duration (long life), create lower EMI-RFI-EME-EMC interference to itself and adjacent environment and ambient conditions either through conducted or radiated emissions and be not susceptible and be immune to the immediate environmental sources. The control system switch can be configured to meet mil-spec standards as required.

In some aspects, the control system switch is the only device in line between the AC source and the load and is the only component capable of reducing the efficiency to the load. The control system switch may meet and perform to consumer, commercial, industrial, and mil-spec standards, as required. The applications can be applied to any electrical distribution system worldwide as it can be configured to operate with any AC of any voltage/current level that is commonly used worldwide. It may benefit the smallest load to large industrial applications. Multiple units may be operated in parallel, or in sequence, to increase capacity. If operated in series, the control system switch performing the greater of the control action may dominate operation of the control. As a new or retrofit to a consumer household the control system switch will control all loads on each side and across the service entry. Specific and custom switches may be applied to any sector or phase requirements. Long life can be assured with aggressive component deration where required. Components of the devices and systems, such as the control system switch or the DCC described above, may be modular providing for the ability to replace defective components. Many other related applications can be derived such a reverse role in a generator mode and direct line switched power supplies and chargers, among others. The control system switch can operate faster than a switched lithium-ion battery controller/charger and add to lithium-ion battery life. The control system switch is self synchronizing when two or more switches are used in series. The normal fail mode for the control system switch is to the fully bypass mode which makes the switch transparent to the load. No additional heating or load alteration should occur and no periodic or routine maintenance is anticipated for the life of the switch.

As a person skilled in the art would recognize, a derated component occurs when the component cannot return to its original or new specification. The component may still work but at a reduced capacity. Severely derated components will ultimately fail. Overating of components to prevent deration is commonly used. Deration occurs in most components and especially in solid state devices.

The control system switch may be controlled by a control element that is a microcontroller (PIC, for example) to perform the necessary TURN ON-TURN OFF sequences required during any given full cycle of the source a/c input. Various sensors may be incorporated to create: base references, sense loads, detect and control start-up, provide system bypass, type of load, monitor system danger/failure characteristics and fall back systems (fail safe). All functions and applications can be done in real time. The microcontroller may perform all control system switch functions on its own or in conjunction with one or more actuator elements. The actuator element may refer to any electrical component referred to herein that causes a current in the circuitry to be turned on or off, including voltage sets, zero switches, drop-out switches. Any other electrical component capable of this functionality as would be readily known to a person skilled in the art may be used as an actuating element. These functions include setting the threshold points at the positive and negative leading turn ‘on’ and trailing turn ‘off’ locations, as well as for other locations on the sine wave. All threshold points could be set at identical levels or all may have individual settings for each threshold point (depending on some sensed characteristic, like time, current or voltage, for example), and track changing loads.

In some aspects, control system switch consumes minimal power from source to load transfer. Moreover, in achieving certain predetermined objectives, such as maintaining the same level of output as a non-sliced AC sine wave, it has been shown to result in load efficiency increases of between 10% and 25%+. To ensure these high load efficiencies the switch itself must consume minimal power as is possible. Some control system switches used in the subject matter disclosed herein have as little as a 1.0v or less at rated output. This provides for minimal heat-sinking. While not a requirement of the subject matter disclosed herein, some such switches are readily available and can be incorporated in modern circuits and offer repeatable results, require minimum components, are cost effective, operate to any load and perform equally well worldwide.

In some aspects, the subject matter disclosed herein may comprise multiple devices (i.e. duty cycle controllers) connected to multiple loads. The multiple devices may be capable of communicating with one another, transmitting information to other devices or to one another, and/or receiving information from other devices or from one another. This communication may permit either centralized or decentralized control of multiple loads. In aspects, a single controller may be used to control the multiple devices. In aspects, each of the multiple devices may have a controller associated with it. In some known systems, control over distributed loads within a home, or neighbourhood, for example, may be employed to ensure a more effective and manageable use of electricity. For example, such control may provide for slight delays in the running of some loads so that they do not all turn on at the same time and cause a spike in electricity consumption. An application of the subject matter in this context may provide for multiple devices starting up with a sliced electrical input to “warm up” the individual devices with normal or near-normal operating output, thereby starting the loads without causing a spike or surge in electricity demand. The control may be centralized in one or more central control centers, or each of the devices may “decide” on its own depending on the activity of all the other related devices and, for example, operate according to an control algorithm. Other examples include control of multiple loads to ensure that an optimal amount of such loads are operating to achieve a particular outcome, rather than turning all on at the same time, and turning all off at the same time. In this latter example, the subject matter disclosed herein provides for a control of such distributed loads such that an optimal operating output of each individual load, according to a particular slicing scheme, is implemented such that the results of the loads as a whole can achieve a particular outcome (e.g. multiple ventilators or air conditioning units maintaining a building at a particular set point). In such an aspect, the distributed control may provide for different threshold points in some loads that result in a very low consumed electrical power consumption (and reduced load output) until some of the loads have started operating at an increase or full power, or it may provide similar threshold points for all loads, resulting in all loads consuming less power, that are gradually adjusted to normal operation. It may also operate in a combination of these.

A slicing scheme may be used in which threshold points are located in the sine wave to account for effects on load operation caused by ambient conditions, such as temperature, EMI or other extraneous interference, ambient light levels. This includes threshold points that are associated with a pre-heating slicing scheme, which is then adjusted to a slicing scheme optimized for a different predetermined objective for that load, or alternatively it may adjust the threshold points of a slicing scheme to account for a change in contributing levels of electrical power versus non-contributing levels as a result of such ambient temperatures. The slicing scheme may be predetermined or it may be implemented in accordance with the control systems described herein.

Some aspects may provide for more efficient battery chargers, in which electricity associated with a portion of the AC sine wave that does not contribute substantially to charging a battery is not transmitted to the load (in this case the charger and/or battery being charged therein).

Some aspects may implement slicing schemes that account for changes in performance of a load due to age. The location of threshold points (and by extension, the electrical energy that contributes and that which does not) may be adjusted in some aspects to account for such aging to control transmission of electrical that, for example, is associated with a reduced ability to achieve an objective of the load as the load ages or does not contribute to the aging of a load (wherein such contribution may itself change over time as the load ages). For the purposes of this paragraph, the term aging in respect of a load may refer to the amount of time since manufacture, the amount of time in operation, or a combination thereof.

Some aspects will use slicing schemes and/or implement real-time adjustment of slicing schemes to optimizing consumption of electrical power in a motor for motors running at variable speeds, including very low, low, high, very high or changing motor speeds. The threshold points may change for the same motor when running under these differing conditions. Moreover, some motors operate as generators at certain times and the subject matter disclosed herein may be configured to both supply energy and slice electricity generated by same. Some motors may receive assistance and/or require that they operate with different levels of power to maintain a constant speed (e.g. a treadmill motor), and some aspects of the subject matter disclosed herein provide a way to regulate the power by adjusting the threshold points but also manage changes to contributing versus non-contributing supplied electricity that result due to such changes in motor requirements.

The predetermined objectives for any load may include any of the following: maintaining a load output at a substantially equivalent level to that as would be output with an unsliced electrical input, extending the lifespan of a particular load by using a slicing scheme to condition the load prior to operation, maintaining an ionization threshold, limiting interference, maintaining interference at a predetermined level or within a predetermined range, accounting for changes in efficiency during the lifetime of a load, achieving a particular unity or power factor, compensating for varying or non-standard electrical inputs (e.g. voltage or current spikes), maintaining heat dissipation or heat generation of a load within a predetermined range or limit, management of load characteristics (e.g. light intensity, colour, etc. of an LED), optimizing the input required for a motor with variable or changing output requirements, equivalent charging time as compared to non-sliced charger input, providing periods of time for communication via the circuitry itself, or any combination thereof. It will be recognized that the achievement of any of these or other load objectives, by way of applying one or more slicing schemes in respect of the electrical power transmitted from the source, will result in a decreased consumption of electricity by the load or loads since there will be periods of time wherein the transmission of electricity will be switched off.

In some aspects of the subject matter disclosed herein, there are provided a number of ways of monetizing the subject matter disclosed herein. Some of these include:
a. Quantifying the difference between the consumed energy by users that employ unsliced and sliced technology and charging a premium fee based on this difference to non-users of the technology;
b. Charging a premium fee for that amount of energy that would be “sliced”;
c. Charging reduced amounts for loads that are configured to operate at the same level with increased “slicing”; and
d. Providing incentives to users or to utility companies based on the gain in efficiencies made possible herein.

There is also provided in some aspects of the subject matter disclosed herein, a use of the circuitry of the subject matter disclosed herein for transmitting information regarding the load operation and/or its output (or its condition due to extraneous factors, such as temperature, ambient light or interference) to the control system circuitry or DCC during times when the circuit is switched “off.” In aspects, the transmission of information may take place when the load is not consuming any electrical energy (i.e., during the sliced portion of the electrical energy that is being transmitted to the load). In aspects, the circuitry may be the same circuit path through which the load (or one or more loads) consumes electrical energy when the electrical energy is not sliced. In some aspects, communication from the control system or the DCC can be sent to the load or other elements (e.g. the control element, the sensing element or the actuating element). Since an LED can be used in an analogous manner to a photovoltaic cell in measuring levels of ambient light, an LED light can act as the sensing element in some aspects, communicating such levels of ambient light to the control and actuating elements via the circuitry itself.

A further aspect or aspect of the subject matter disclosed herein, provides for methods of reducing electrical energy to one or more loads that does not materially contribute to a predetermined objective of the one or more loads by switching off the current when a characteristic of the current reaches predetermined first threshold and switching the current on when the current reaches a predetermined second threshold, wherein the current transmitted between the first and second thresholds provides a lower contribution in achieving the predetermined objective. In a sinusoidal AC signal, the threshold points may be associated with portions of the AC current that do not, for example, provide sufficient electrical energy to cause an incandescent light bulb to provide light, to cause a motor to provide motive force or work, to cause an element, filament or ionizable gas to heat up to sufficiently operate at expected levels. It may also include energy that provides extraneous or surplus electrical energy that is already provided by another portion of the electrical signal, which is practically not necessary. Examples of this would include the heat created by portions of the electrical signal that cause a light bulb to emit light. Since other portions of the signal have caused the filament to heat up sufficiently to allow the bulb to emit light, the portions of the signal, while they do cause the filament to heat up even more, cause a surplus of heat energy that is not required for the filament to emit light and is essentially wasted energy. Other examples may include the surplus energy that is provided to a fluorescent light that is in excess, by a some degree, of the level of electrical energy required to maintain ionization. Such surplus energy is nevertheless considered to be non-contributing to a predetermined objective.

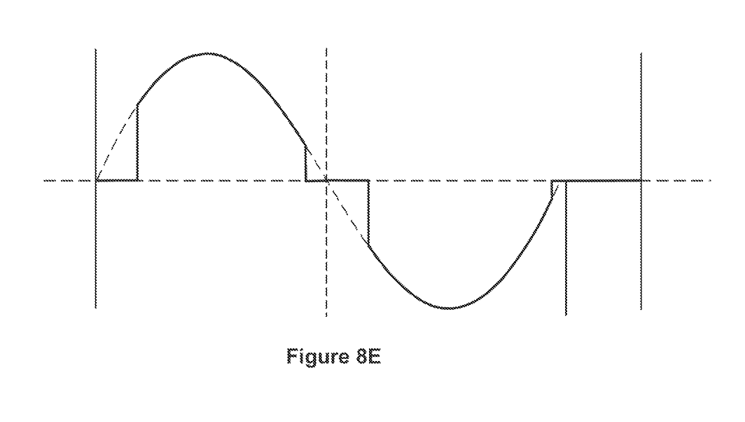

In accordance with one aspect of the subject matter disclosed herein, there is a control system configured to turn the zero switches, voltage sets, or drop-out switches, or other switching devices capable of performing this functionality, on or off when a respective first or second threshold point has been reached. In other aspects, the elements themselves may be configured to actuate the change (i.e. turning the current on or off). Referring to FIG. 9, there is a representative flowchart showing a method in accordance with one aspect of the subject matter disclosed herein. In the method shown in FIG. 9, the decision points may be carried out by a control system or a controller. In aspects, referring to FIG. 9, the control system may determine if a characteristic of the electrical energy equals a first predetermined threshold point 901 and switch “OFF” the electrical energy to the load 902 if the determination is “YES” or if the determination is“NO”, the control system keeps the electrical energy to the load “ON” 903. When the electrical energy to the load is “OFF”, the control system will determine if the characteristic of the electrical energy equals a predetermined second threshold point 904 and switch “ON” the electrical energy to the load 903 if the determination is “YES” or if the determination is “NO”, the control system keeps the electrical energy to the load “OFF” 902. The flowchart in FIG. 9 is intended to show an exemplary method in accordance with the subject matter disclosed herein, and the fact that no starting or ending points are shown in FIG. 9 is not intended to limit the demonstrative nature thereof.

Also provided is a method of controlling or optimizing the slicing scheme to ensure that non-contributing electrical energy is minimized in real time, irrespective of whether the initial threshold points have been used optimally or conditions have changed, while ensuring that the predetermined objective is not substantially impacted by changes thereto. Such methods comprise the steps of operating a slicing scheme with thresholds for switching current on and off to one or more loads, measuring one or more sensed characteristics that are indicative of the status of the achievement of the predetermined objective by the one or more loads, adjusting one or more threshold levels in accordance with the one or more sensed characteristics, and then repeating the sensing and adjustment steps. This method can be implemented to adjust one or more threshold points and/or to iteratively cycle through all the threshold points. The predetermined objective in this case may include multiple factors, including for example, maintaining a particular operational objective while maintaining interference below a particular threshold. Moreover, a non-material or insubstantial change in the predetermined objective may be acceptable with certain predetermined limits. For example, it may be acceptable to allow brightness in a light bulb to reduce to a particular level and levels of interference to rise to commercially acceptable standards, in light of substantial savings in efficiency. As such, a material or substantial reduction in performance might only be achieved once the reduction in performance has breached some predetermined limit for performance. Substantial and material is therefore based on the context in which they are used. Finally, the method may include steps wherein the sensed characteristic is communicated to the control system via the same circuitry over which the current is transmitted to load during periods in which the load is switched off.

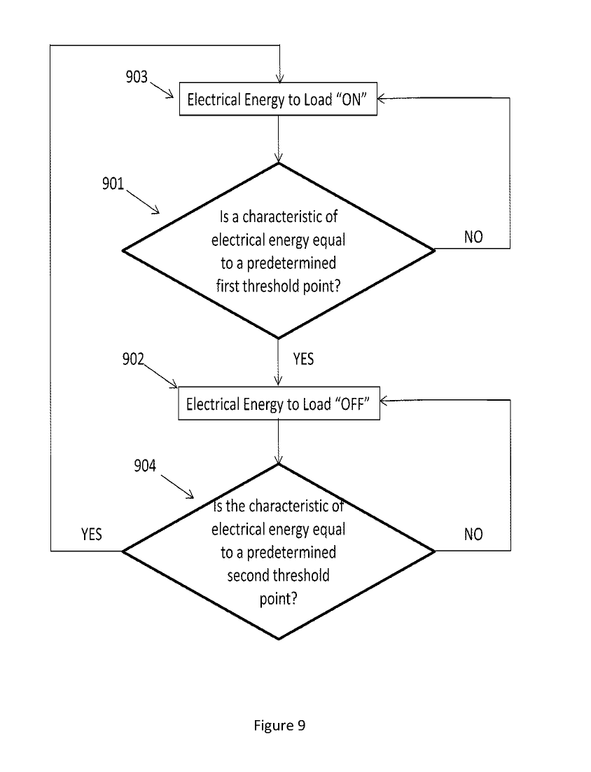

Referring to FIG. 10, there is shown an exemplary method of controlling or optimizing, via a control system or one or more controllers, the electrical energy consumed by a load in achieving a predetermined objective. It should be noted that the order in which the iteration of first and second threshold points occurs may be different in different aspects, as may the assessment of the characteristic, which may be sensed by one or more sensors, indicating the status of the predetermined load objective. Additionally, the adjustment and assessment as shown, which is sequential and iterative, may be done in alternative ways in parallel and/or non-iteratively. The method of FIG. 10 is intended to be illustrative of the control process, but a similar process of feedback control of adjusting the threshold pairs (i.e. first and second threshold points bounding a period when the current is turned off) based on a sensed characteristic indicative of the load objective may be used without departing from the scope and spirit of the subject matter disclosed herein.

In aspects, referring to FIG. 10, the control system may determine if predetermined objective of the load (one or more loads) is being met or not 1001. If the predetermined objective of the load is being met (i.e. if the answer to the question in the decision element 1001 is “YES”) then the control system may adjust the threshold points to reduce the electrical energy supplied to the load 1002 and then the control system further checks if the predetermined objective of the load is still being met 1003. If the answer to the question in the decision element 1003 is “YES” then the optimization method loops back to 1002 and keeps adjusting the threshold points. If the answer to the question in the decision element 1003 is “NO” then the control system undoes the last change 1004 and stops. Referring to reference element 1001, if the predetermined objective of the load is not being met (i.e., if the answer to the question in the decision element 1001 is “NO”) then the control system adjusts the threshold points to increase the electrical energy supplied to the load 1005. The control system further checks if the objective of the load is being met 1006. If the answer to the question in the decision element 1006 is “NO”, then the method loops back to 1005 and keeps adjusting the threshold points. If the answer to the question in the decision element 1006 is “YES”, then the optimization method loops back to 1002 and adjusts the threshold points to reduce electrical energy supplied to load. The control system then further checks if the predetermined objective of the load is still being met 1003. If the answer to the question in the decision element 1003 is “YES” then the optimization method loops back to 1002 again and keeps adjusting the threshold points. If the answer to the question in the decision element 1003 is “NO” then the control system undoes the last change 1004 and stops. The optimization method described in FIG. 10 may be applied at regular or irregular intervals, automatically, manually or as otherwise known to a worker skilled in the art.

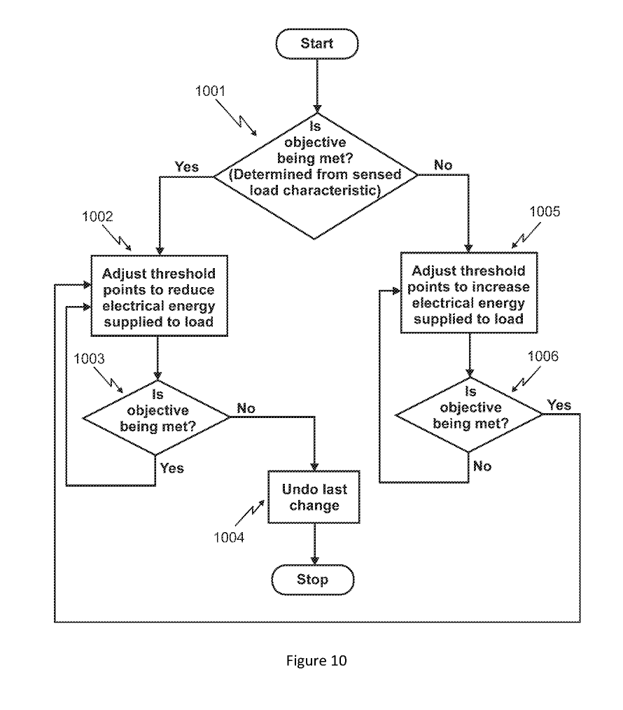

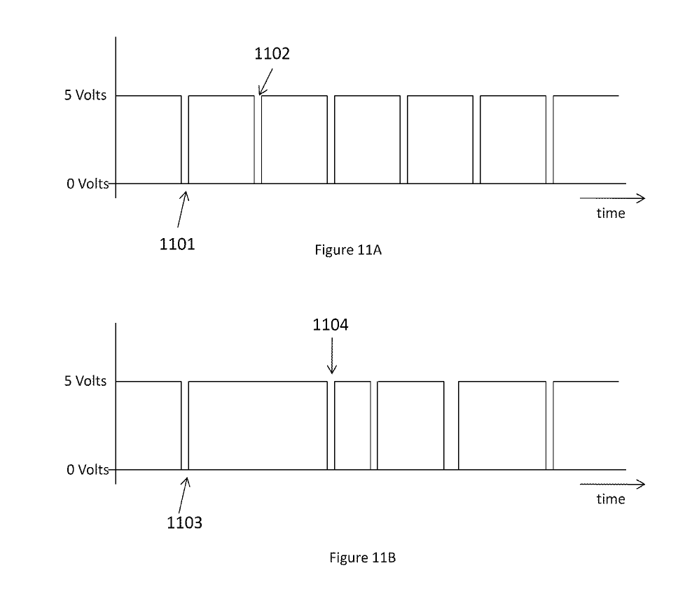

In aspects, the slicing scheme described herein may be applied to an electrical energy that is a direct current (DC). The slicing of DC may be at regular intervals as shown in FIG. 11A or at irregular intervals as shown in FIG. 11B. It is to be understood that the values used in FIGS. 11A and 11B are solely exemplary. As such, the values may corresponded to any DC value. In aspects, there may be a predetermined slicing scheme of the DC that may be applied to a load. For example, the predetermined slicing of the DC may take place every 5 seconds having periods of non-transmission of electrical energy of 0.01 seconds (referring to FIG. 11A, 1101 may be at 5 seconds for a period of 0.01 seconds and 1102 may be at 10 seconds for a period of 0.01 seconds and so on and so forth); in other words, the time of transmission, of non-transmission, or since the last switching on or off of the electrical energy to the one or more loads may be and the characteristic of the electrical energy that, when such a characteristic reaches a predetermined level, triggers a slicing of the DC signal. Using FIGS. 11A and 11B as examples, at 1101 and 1102, electrical energy is not being transmitted to the load. As another example, referring to FIG. 11B, the slicing of the DC signal may take place at 5 seconds then at 14 seconds; hence contributing to irregular slicing. Referring to FIG. 11B, at 1103 and 1104 there is no electrical energy being transmitted to the load; transmission of the electrical energy has been switched off at the beginning of the respective periods shown by elements 1103 and 1104, and switched back on and the end of each such period, and in such example the characteristic of the electrical energy is the duration since the last switching on or off of the electrical energy.

In aspects, the slicing of the DC may be based on whether a predetermined objective of the load is being met or not. In aspects, initially a non-sliced DC may be applied to a given load and based on the predetermined objective of the load being met, the input to the load may be altered by slicing the applied DC to the load in such a fashion that the consumed energy by the load may be reduced without any sacrifice in the output of the load (i.e., the predetermined objective of the load still being maintained regardless of the decrease in consumed electrical energy by the load due to slicing of the DC). This may be referred to as optimizing the input DC to the load based on the predetermined objective of the load being met.

In some aspects of the subject matter disclosed herein, there is provided a system comprising a source, one or more loads, and a device in accordance with the disclosure hereof disposed therebetween, wherein the device acts to restrict the flow, to the one or more loads from the source, of electrical energy that does not materially contribute to the one or more loads in achieving a predetermined objective.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

Although the subject matter disclosed herein has been described above by reference to certain aspects of the subject matter disclosed herein, the subject matter disclosed herein is not limited to the aspects described above. Modifications and variations of the aspects described above will occur to those skilled in the art in light of the above teachings.

What is claimed is:

1. A method of reducing consumption of electrical energy by one or more loads, the method comprising the steps of:
a) switching off the electrical energy to the one or more loads when a characteristic of the electrical energy equals a predetermined first threshold point;
b) switching on the electrical energy to the one or more loads when the characteristic of the electrical energy equals a predetermined second threshold point; and
c) repeating steps a) and b);
wherein the electrical energy between the predetermined first and second threshold points is associated with a reduced contribution in achieving a predetermined objective of the one or more loads.

2. A method of optimizing reduction in consumption of electrical energy by one or more loads, the method comprising the steps of:
a) switching off the electrical energy to the one or more loads when a characteristic of the electrical energy is between a predetermined first threshold point and a predetermined second threshold point, wherein the electrical energy between the predetermined first and second threshold points is associated with a reduced contribution in achieving a predetermined objective of the one or more loads;
b) determining one or more sensed characteristics of the one or more loads indicative of whether or not the predetermined objective is being met; and
c) adjusting the predetermined first and second threshold points to either,
(i) reduce the consumption of electrical energy by the one or more loads if the predetermined objective is being met; or
(ii) increase the consumption of electrical energy by the one or more loads if the predetermined objective is not being met.

3. A system for reducing consumption of electrical energy by one or more loads, the system comprising a device coupled with an electrical energy source and the one or more loads, the device configured to:
a) switch off the electrical energy to the one or more loads when a characteristic of the electrical energy equals a predetermined first threshold point;
b) switch on the electrical energy to the one or more loads when the characteristic of the electrical energy equals a predetermined second threshold point; and
c) repeat steps a) and b);
wherein the electrical energy between the predetermined first and second threshold points is associated with a reduced contribution in achieving a predetermined objective of the one or more loads.

4. The system of claim 3, wherein the device is a duty cycle controller.

5. The system of claim 3, wherein the electrical energy source is a power generating station or a power outlet on the wall.

6. The system of claim 3, wherein said device is multiple devices.

7. The system of claim 6, wherein said multiple devices are distributed across multiple loads.

8. The system claim 7, wherein said multiple devices are in communication with one another.

9. The system of claim 8, wherein said communication provides for a centralized or decentralized control of the multiple loads.

10. The system of claim 3, wherein said device is further operatively connected to an electrical energy diverting device that diverts electrical energy that is between the predetermined first and second threshold points.

11. A system for optimizing reduction in consumption of electrical energy by one or more loads, the system comprising:
a) a device coupled with an electrical energy source and the one or more loads, the device configured to switch off the electrical energy to the one or more loads when a characteristic of the electrical energy is between a predetermined first threshold point and a predetermined second threshold point, wherein the electrical energy between the predetermined first and second threshold points is associated with a reduced contribution in achieving a predetermined objective of the one or more loads;
b) one or more sensing elements coupled with the one or more loads, the one or more sensing elements configured to determine one or more sensed characteristics indicative of whether or not the predetermined objective is being met; and
c) a controller in operative communication with the device, the one or more sensing elements and the one or more loads, the controller configured to adjust the predetermined first and second threshold points to either,
(i) reduce the consumption of electrical energy by the one or more loads if the predetermined objective is being met; or
(ii) increase the consumption of electrical energy by the one or more loads if the predetermined objective is not being met.

12. The system of claim 11, where in the device is a duty cycle controller.

13. The system of claim 11, wherein the electrical energy source is a power generating station or a power outlet on the wall.

14. The system of claim 11, wherein said device is multiple devices.

15. The system of claim 14, wherein said multiple devices are distributed across multiple loads.

16. The system claim 15, wherein said multiple devices are in communication with one another.

17. The system of claim 16, wherein said communication provides for a centralized or decentralized control of the multiple loads.

18. The system of claim 11, wherein said device is further operatively connected to an electrical energy diverting device that diverts electrical energy that is between the predetermined first and second threshold points.

19. The system of claim 11, wherein said controller is further configured to either reduce or increase the consumption of electrical energy by the one or more loads based on environmental conditions of the one or more loads.

20. The system of claim 11, wherein said controller receives the one or more sensed characteristics, when the electrical energy is between the predetermined first and second threshold points, via a circuit path that is same as the one through which the one or more loads consume electrical energy.

21. The system of claim 20, wherein said one or more sensed characteristics are of the one or more loads or of one or more load environmental conditions.

22. A device for reducing consumption of electrical energy by one or more loads, the device comprising a first zero switch and a second zero switch that are in operative connection with a reference controller, which is continuously connected to an electrical energy source, the device configured to:
a) switch off the electrical energy to the one or more loads when a characteristic of the electrical energy equals a predetermined first threshold point;
b) switch on the electrical energy to the one or more loads when the characteristic of the electrical energy equals a predetermined second threshold point; and
c) repeat steps a) and b);
wherein the electrical energy between the predetermined first and second threshold points is associated with a reduced contribution in achieving a predetermined objective of the one or more loads.

23. The device of claim 22, wherein the electrical energy source is a line voltage.

24. The device of claim 23, wherein the reference controller comprises a reference voltage setting device.

25. The device of claim 24, wherein the reference voltage setting device is a zener diode.

26. The device of claim 22, wherein said device is further operatively connected to an electrical energy diverting device that diverts electrical energy that is between the predetermined first and second threshold points.

27. A controller for optimizing reduction in consumption of electrical energy by one or more loads, the controller comprising one or more processors, the one or more processors in operative communication with a device and with one or more sensing elements of the one or more loads, the one or more processors configured to:
a) control the device to switch off the electrical energy to the one or more loads when a characteristic of the electrical energy is between a predetermined first threshold point and a predetermined second threshold point, wherein the electrical energy between the predetermined first and second threshold points is associated with a reduced contribution in achieving a predetermined objective of the one or more loads;
b) receive one or more sensed characteristics from one or more sensing elements indicative of whether or not the predetermined objective is being met; and
c) further control the device to adjust the predetermined first and second threshold points to either,
(i) reduce the consumption of electrical energy by the one or more loads if the predetermined objective is being met; or
(ii) increase the consumption of electrical energy by the one or more loads if the predetermined objective is not being met.

28. The controller of claim 27, wherein the device is a duty cycle controller.

29. The controller of claim 27, wherein said controller is further configured to either reduce or increase the consumption of electrical energy by the one or more loads based on environmental conditions of the one or more loads.

30. The controller of claim 27, wherein said controller receives the one or more sensed characteristics, when the electrical energy is between the predetermined first and second threshold points, via a circuit path that is same as the one through which the one or more loads consume electrical energy.

31. The controller of claim 30, wherein said one or more sensed characteristics are of the one or more loads or of one or more environmental conditions of the one or more loads.

32. A device for reducing the consumption of electrical energy of resistive, inductive or combination loads comprising: a duty cycle controller having two zero switches in line with a reference controller for connection across opposite sides of a line voltage, the two zero switches include a positive zero switch and a negative zero switch.

33. A device for reducing consumption of electrical energy by a load, the device comprising a first zero switch and a second zero switch that are in operative connection with a reference controller, which is continuously connected to a source, the device configured to:
a) apply the electrical energy from the source to the load until a reference threshold voltage is reached and then stop the electrical energy from the source to the load until the electrical energy reaches a preset reference level; and
b) repeat for each zero crossing of the electrical energy;
wherein the electrical energy between the reference threshold voltage and the preset reference level does not supply useful power to the load.

34. The device according to claim 33, wherein the zero switches are gated power switches.

35. The device according to claim 33, wherein the reference controller comprises a reference voltage setting device.

36. The device of claim 35, wherein the reference voltage setting device is a zener diode.

37. The device according to claim 33, wherein the reference controller is fixed or variable.

38. The device according to claim 33, wherein the reference controller further comprises a threshold control means for manual or programmed control of positive and negative threshold voltages.

39. The device according to claim 38, wherein the threshold control means include fixed, variable or digital triggering for constant control or for setting a threshold level.

40. The device according to claim 32, wherein the reference controller is continuously connected to a line voltage.

41. A device for switching the zero switches of claim 33 for restricting flow of an alternating current and controlling the amount of energy consumed by a load of the alternating current.

42. The device of claim 41, further comprising a programmed peripheral interface micro controller in line with a full wave rectifier for switching solid state switches.

43. The device of claim 42, wherein the peripheral interface controller is PC16F917.

44. The device of claim 42, wherein the full wave rectifier has over-current and over voltage protection.

45. The device of claim 42, wherein the micro-controller interprets a signal from the full-wave rectifier to determine when to operate the solid state switches; to determine if a voltage present on a high-side of a transformer is unsuitable for a predetermined load; and to determine if the alternating current signal is either over or under frequency.

46. A method for reducing the consumption of electrical energy of resistive, inductive or combination loads comprising: a duty cycle controller having a positive zero switch and a negative zero switch in line with a reference controller for connection across opposite sides of a line voltage.

47. A system for reducing the consumption of electrical energy of resistive, inductive or combination loads comprising: a duty cycle controller having a positive zero switch and a negative zero switch in line with a reference controller for connection across opposite sides of a line voltage.

48. A method of supplying electrical energy to a load from a source, the method comprising the steps of:
a) applying the electrical energy from the source to the load until a reference threshold voltage is reached and then stopping the electrical energy from the source to the load until the electrical energy reaches a preset reference level; and
b) repeating for each zero crossing of the electrical energy;
wherein the electrical energy between the reference threshold voltage and the preset reference level does not supply useful power to the load.

49. A system comprising a device in operative communication with a source and a load, the device configured to:
a) apply electrical energy from the source to the load until a reference threshold voltage is reached and then stop the electrical energy from the source to the load until the electrical energy reaches a preset reference level; and
b) repeat for each zero crossing of the electrical energy;
wherein the electrical energy between the reference threshold voltage and the preset reference level does not supply useful power to the load.
